(19) United States
(12) Patent Application Publication
(10) Pub. No.: US 2023/0337157 A1
(43) Pub. Date: Oct. 19, 2023

(54) METHOD FOR TRANSMITTING AND RECEIVING, BY USER EQUIPMENT, SIGNALS BY USING PLURALITY OF DISTRIBUTED ANTENNAS IN WIRELESS COMMUNICATION SYSTEM SUPPORTING SIDELINK, AND APPARATUS THEREFOR

(71) Applicant: LG Electronics Inc., Seoul (KR)

(72) Inventors: Heejin KIM, Seoul (KR); Hanbyul SEO, Seoul (KR); Seungmin LEE, Seoul (KR)

(21) Appl. No.: 18/026,955

(22) PCT Filed: Sep. 14, 2021
(86) PCT No.: PCT/KR2021/012450

§ 371 Date: Mar. 17, 2023

(30) Foreign Application Priority Data
Sep. 25, 2020 (KR) 10-2020-0125127

(51) Int. Cl. H04W 56/00

(52) U.S. Cl. CPC H04W 56/0015

(57) ABSTRACT

Disclosed are a method for transmitting and receiving, by user equipment, signals by using a plurality of distributed antennas in a wireless communication system supporting sidelink according to various embodiments, and an apparatus therefor. Disclosed are the method and the apparatus therefor, the method comprising the steps of: transmitting a first signal by using the plurality of distributed antennas; and receiving a second signal from a base station by using the plurality of distributed antennas, wherein the second signal includes time gap information for the alignment of timings between the plurality of distributed antennas, and the timings of the plurality of distributed antennas are aligned on the basis of the time gap information.

### TECHNICAL FIELD

The present disclosure relates to a method in which a user equipment (UE) aligns timings of a plurality of distributed antennas by transmitting and receiving signals on the plurality of distributed antennas in a wireless communication system supporting sidelink and apparatus therefor.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

A sidelink (SL) refers to a communication method in which a direct link is established between user equipment (UE), and voice or data is directly exchanged between terminals without going through a base station (BS). SL is being considered as one way to solve the burden of the base station due to the rapidly increasing data traffic.

V2X (vehicle-to-everything) refers to a communication technology that exchanges information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR). Even in NR, vehicle-to-everything (V2X) communication may be supported.

FIG. 1 is a diagram comparing RAT-based V2X communication before NR with NR-based V2X communication.

Regarding V2X communication, in RAT prior to NR, a scheme for providing a safety service based on V2X messages such as a basic safety message (B SM), a cooperative awareness message (CAM), and a decentralized environmental notification message (DENM) was mainly discussed. The V2X message may include location information, dynamic information, and attribute information. For example, the UE may transmit a periodic message type CAM and/or an event triggered message type DENM to another UE.

For example, the CAM may include dynamic state information about a vehicle such as direction and speed, vehicle static data such as dimensions, and basic vehicle information such as external lighting conditions and route details. For example, a UE may broadcast the CAM, and the CAM latency may be less than 100 ms. For example, when an unexpected situation such as a breakdown of the vehicle or an accident occurs, the UE may generate a DENM and transmit the same to another UE. For example, all vehicles within the transmission coverage of the UE may receive the CAM and/or DENM. In this case, the DENM may have a higher priority than the CAM.

Regarding V2X communication, various V2X scenarios have been subsequently introduced in NR. For example, the various V2X scenarios may include vehicle platooning, advanced driving, extended sensors, and remote driving.

For example, based on vehicle platooning, vehicles may dynamically form a group and move together. For example, to perform platoon operations based on vehicle platooning, vehicles belonging to the group may receive periodic data from a leading vehicle. For example, the vehicles belonging to the group may reduce or increase the distance between the vehicles based on the periodic data.

For example, based on advanced driving, a vehicle may be semi-automated or fully automated. For example, each vehicle may adjust trajectories or maneuvers based on data acquired from local sensors of nearby vehicles and/or nearby logical entities. Also, for example, each vehicle may share driving intention with nearby vehicles.

For example, on the basis of extended sensors, raw data or processed data acquired through local sensors, or live video data may be exchanged between a vehicle, a logical entity, UEs of pedestrians and/or a V2X application server. Thus, for example, the vehicle may recognize an environment that is improved over an environment that may be detected using its own sensor.

For example, for a person who cannot drive or a remote vehicle located in a dangerous environment, a remote driver or V2X application may operate or control the remote vehicle based on remote driving. For example, when a route is predictable as in the case of public transportation, cloud computing-based driving may be used to operate or control the remote vehicle. For example, access to a cloud-based back-end service platform may be considered for remote driving.

A method to specify service requirements for various V2X scenarios such as vehicle platooning, advanced driving, extended sensors, and remote driving is being discussed in the NR-based V2X communication field.

### DISCLOSURE

### Technical Problem

The object of the present disclosure is to provide a method and apparatus for minimizing communication performance degradation based on a plurality of distributed antennas by obtaining timing offsets between the plurality of distributed antennas from signal transmission and reception with a base station (BS) and effectively aligning the timings of the plurality of distributed antennas.

It will be appreciated by those of ordinary skill in the art to which the embodiment(s) pertain that the objects that could be achieved with the embodiment(s) are not limited to what has been particularly described hereinabove and the above and other objects will be more clearly understood from the following detailed description.

### Technical Solution

In an aspect of the present disclosure, there is provided a method of transmitting and receiving, by a user equipment (UE), signals on a plurality of distributed antennas in a wireless communication system supporting sidelink. The method may include: transmitting a first signal to a base station (BS); and receiving a second signal from the BS. The first signal may be transmitted on the plurality of distributed antennas, and the second signal may be received on the plurality of distributed antennas. The second signal may include time gap information for timing alignment between the plurality of distributed antennas, and timings of the plurality of distributed antennas may be aligned based on the time gap information.

Alternatively, the time gap information may include a time gap between a timing at which the first signal transmitted on each of the plurality of distributed antennas is received and a timing of a time resource allocated to the first signal.

Alternatively, the time gap information may include information on a time gap between a reception timing of the first signal related to a reference distributed antenna among the plurality of distributed antennas and a reception timing related to each distributed antenna.

Alternatively, the timings of the plurality of distributed antennas may be aligned based on a value obtained by subtracting a timing offset depending on an air interface with the BS from the time gap, and the timing offset may be obtained by subtracting a propagation delay related to each distributed antenna from a propagation delay related to the reference distributed antenna.

Alternatively, the timing offset may be calculated based on a difference between a distance between the reference distributed antenna and the BS and a distance between each distributed antenna and the BS.

Alternatively, the timings of the plurality of distributed antennas may be aligned with respect to a timing of the reference antenna among the plurality of distributed antennas, and a distributed antenna having any one of an earliest timing, a latest timing, and an average timing among the timings of the plurality of distributed antennas may be determined as the reference distributed antenna based on the time gap information.

Alternatively, a timing advance (TA) value related to the UE may be determined based on a timing of the distributed antenna determined as the reference distributed antenna.

Alternatively, each of the plurality of distributed antennas may be configured to adjust transmission and reception timings based on a timing offset calculated based on the time gap information, and the timing offset may be a difference between the timing of the reference distributed antenna and a timing of each of the plurality of distributed antennas.

Alternatively, the UE may further include a center antenna configured to control the plurality of distributed antennas. The timing offset may be calculated by the center antenna and transferred to each of the plurality of distributed antennas over a first interface. The first interface may be an interface configured to transfer digital information between each of the plurality of distributed antennas and the center antenna.

Alternatively, the first signal may be an uplink signal for the BS or a tracking reference signal (TRS) for the timing alignment of the distributed antennas, and the second signal may be a downlink signal.

In another aspect of the present disclosure, there is provided a method of transmitting, by a BS, a second signal to a UE in a wireless communication system supporting sidelink. The method may include: receiving a first signal transmitted by the UE on a plurality of distributed antennas; and transmitting a second signal including time gap information for timing alignment between the plurality of distributed antennas. The time gap information may include a time gap between a reception timing of the first signal for each of the plurality of distributed antennas and a timing of a time resource allocated to the first signal.

In another aspect of the present disclosure, there is provided a UE configured to transmit and receive signals on a plurality of distributed antennas in a wireless communication system supporting sidelink. The UE may include: a radio frequency (RF) transceiver; and a processor connected to the RF transceiver. The processor may be configured to: control the plurality of distributed antennas including the RF transceiver to transmit a first signal; receive a second signal from a BS; and align timings of the distributed antennas based on the second signal. The second signal may include time gap information for timing alignment between the plurality of distributed antennas.

Alternatively, the time gap information may include a time gap between a reception timing of the first signal for each of the plurality of distributed antennas and a timing of a time resource allocated to the first signal.

In another aspect of the present disclosure, there is provided a BS configured to transmit a second signal to a UE in a wireless communication system supporting sidelink in a wireless communication system supporting sidelink. The BS may include: an RF transceiver; and a processor connected to the RF transceiver. The processor may be configured to: control the RF transceiver to receive a first signal transmitted by the UE on a plurality of distributed antennas; and transmit a second signal including time gap information for timing alignment between the plurality of distributed antennas. The time gap information may include a time gap between a reception timing of the first signal for each of the plurality of distributed antennas and a timing of a time resource allocated to the first signal.

In another aspect of the present disclosure, there is provided a chipset configured to transmit and receive signals on a plurality of distributed antennas in a wireless communication system supporting sidelink. The chipset may include: at least one processor; and at least one memory operably connected to the at least one processor and configured to, when executed, cause the at least one processor to perform operations. The operations may include: controlling a plurality of distributed antennas to transmit a first signal; receiving a second signal from a BS; and aligning timings of the distributed antennas based on the second signal. The second signal may include time gap information for timing alignment between the plurality of distributed antennas.

Alternatively, the processor may be configured to control a driving mode of a device connected to the chipset based on the second signal.

In a further aspect of the present disclosure, there is provided a computer-readable storage medium including at least one computer program configured to cause at least one processor to perform operations of transmitting and receiving signals in a wireless communication system supporting sidelink. The at least one computer program may be configured to cause the at least one processor to perform the operations of transmitting and receiving the signals on a plurality of distributed antennas, and the at least one computer program may be stored on the computer-readable storage medium. The operations may include: controlling the plurality of distributed antennas to transmit a first signal; receiving a second signal from a BS; and aligning timings of the distributed antennas based on the second signal. The second signal may include time gap information for timing alignment between the plurality of distributed antennas.

### Advantageous Effects

According to various embodiments, timings of a plurality of distributed antennas may be effectively aligned by obtaining timing offsets between the plurality of distributed antennas from signal transmission and reception with a base station (BS), thereby minimizing communication performance degradation based on the plurality of distributed antennas.

Effects to be achieved by embodiment(s) are not limited to what has been particularly described hereinabove and other effects not mentioned herein will be more clearly understood by persons skilled in the art to which embodiment(s) pertain from the following detailed description.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 is a diagram for explaining by comparing V2X communication based on RAT before NR and V2X communication based on NR.

FIG. 2 illustrates the structure of an LTE system to which embodiment(s) are applicable.

FIG. 3 illustrates the structure of an NR system to which embodiment(s) are applicable.

FIG. 4 illustrates the structure of an NR radio frame to which embodiment(s) are applicable.

FIG. 5 illustrates the slot structure of an NR frame to which embodiment(s) are applicable.

FIG. 6 illustrates a radio protocol architecture for SL communication.

FIG. 7 illustrates UEs performing V2X or SL communication.

FIG. 8 illustrates resource units for V2X or SL communication.

FIG. 9 illustrates a procedure in which UEs perform V2X or SL communication according to a transmission mode.

FIG. 10 is a diagram for explaining a distributed antenna unit system provided in a V2X vehicle.

FIGS. 11 and 12 are diagrams for explaining implementation options for a DAS.

FIG. 13 is a diagram for explaining a UE in a vehicle equipped with distributed antennas.

FIG. 14 is a diagram for explaining a method in which a UE aligns timings of a plurality of distributed antennas.

FIG. 15 is a diagram for explaining a method in which a BS transmits a second signal based on a first signal.

FIG. 16 illustrates a communication system applied to the present disclosure.

FIG. 17 illustrates wireless devices applicable to the present disclosure.

FIG. 18 illustrates another example of a wireless device to which the present disclosure is applied.

FIG. 19 illustrates a vehicle or an autonomous driving vehicle applied to the present disclosure.

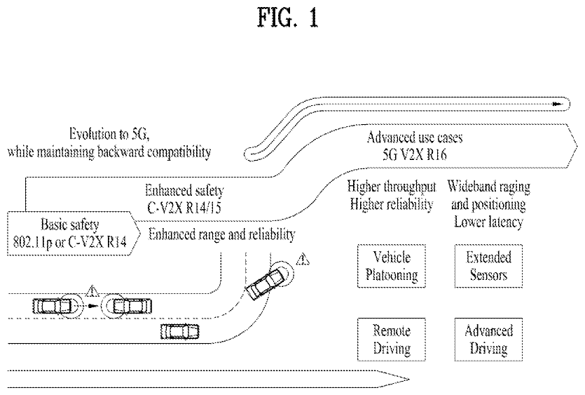

### DETAILED DESCRIPTION

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A, and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto.

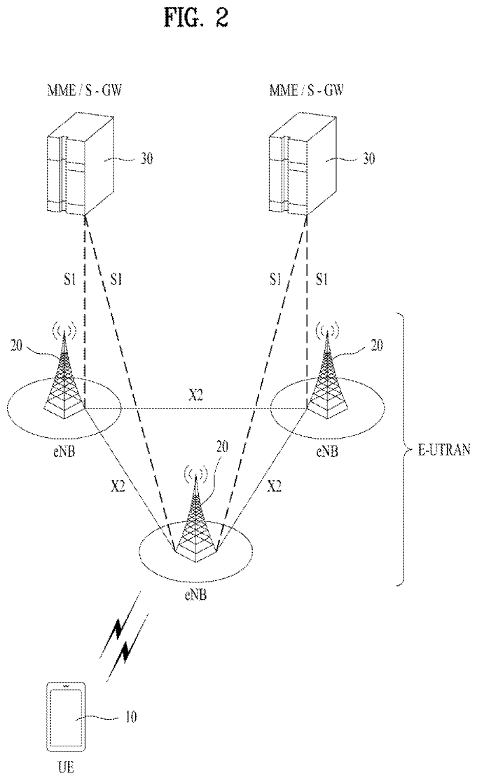

FIG. 2 illustrates the structure of an LTE system to which the present disclosure is applicable. This may also be called an evolved UMTS terrestrial radio access network (E-UTRAN) or LTE/LTE-A system.

Referring to FIG. 2, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at L1 provides an information transfer service on physical channels. The radio resource control (RRC) layer at L3 functions to control radio resources between the UE and the network. For this purpose, the RRC layer exchanges RRC messages between the UE and an eNB.

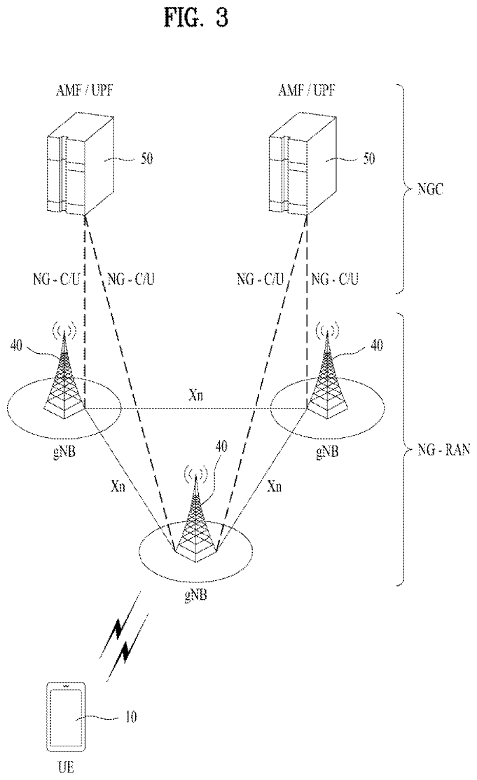

FIG. 3 illustrates the structure of a NR system to which the present disclosure is applicable.

Referring to FIG. 3, a next generation radio access network (NG-RAN) may include a next generation Node B (gNB) and/or an eNB, which provides user-plane and control-plane protocol termination to a UE. In FIG. 3, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

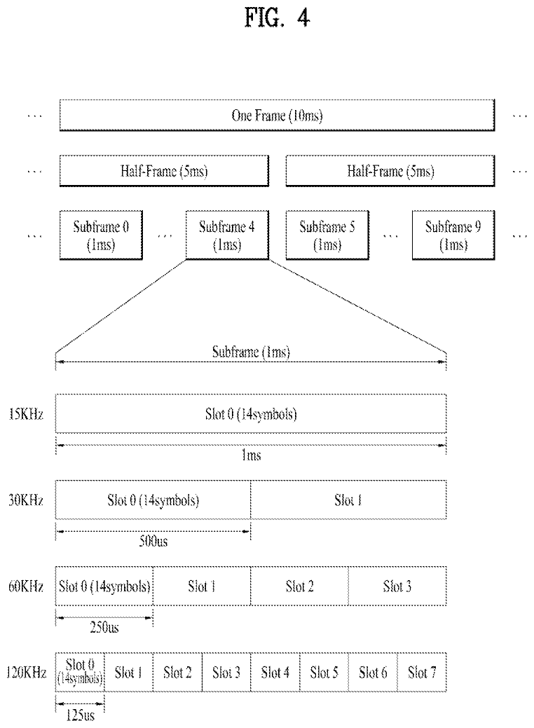

FIG. 4 illustrates the structure of a NR radio frame to which the present disclosure is applicable.

Referring to FIG. 4, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM(A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,u}ₛₗₒₜ, and the number of slots per subframe N^{subframe,u}ₛₗₒₜ according to an SCS configuration μ in the NCP case.

TABLE 1

| SCS (15*2u) | N^{slot}_{symb} | N^{frame, u}ₛₗₒₜ | N^{subframe, u}ₛₗₒₜ |
|---|---|---|---|
| 15 kHz (u = 0) | 14 | 10 | 1 |
| 30 kHz (u = 1) | 14 | 20 | 2 |
| 60 kHz (u = 2) | 14 | 40 | 4 |
| 120 kHz (u = 3) | 14 | 80 | 8 |
| 240 kHz (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 kHz (u = 2) | 12 | 40 | 4 |

In the NR system, different OFDM(A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding | Subcarrier |
|---|---|---|
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

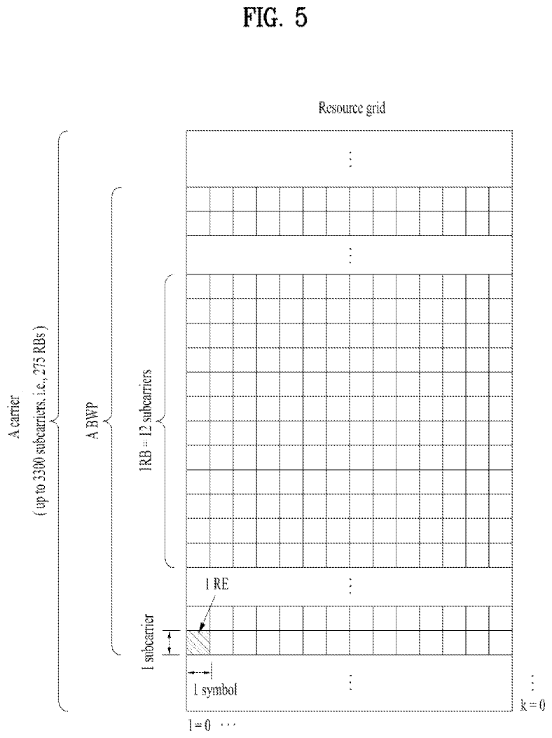

FIG. 5 illustrates the slot structure of a NR frame to which the present disclosure is applicable.

Referring to FIG. 5, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P)RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

Hereinafter, V2X or sidelink (SL) communication will be described.

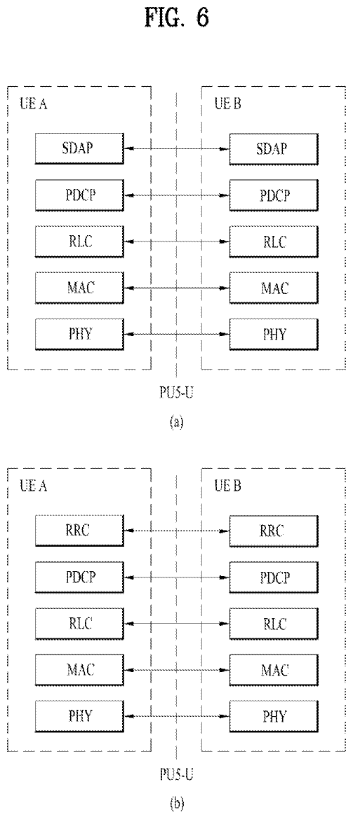

FIG. 6 illustrates a radio protocol architecture for SL communication. Specifically, FIG. 6-(a) shows a user plane protocol stack of NR, and FIG. 6-(b) shows a control plane protocol stack of NR.

Hereinafter, a sidelink synchronization signal (SLSS) and synchronization information will be described.

The SLSS is an SL-specific sequence, and may include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, the UE may detect an initial signal and acquire synchronization using the S-PSS. For example, the UE may acquire detailed synchronization using the S-PSS and the S-SSS, and may detect a synchronization signal ID.

A physical sidelink broadcast channel (PSBCH) may be a (broadcast) channel on which basic (system) information that the UE needs to know first before transmission and reception of an SL signal is transmitted. For example, the basic information may include SLSS related information, a duplex mode (DM), time division duplex uplink/downlink (TDD UL/DL) configuration, resource pool related information, the type of an application related to the SLSS, a subframe offset, and broadcast information. For example, for evaluation of PSBCH performance, the payload size of PSBCH in NR V2X may be 56 bits including CRC of 24 bits.

The S-PSS, S-SSS, and PSBCH may be included in a block format (e.g., an SL synchronization signal (SS)/PSBCH block, hereinafter sidelink-synchronization signal block (S-SSB)) supporting periodic transmission. The S-SSB may have the same numerology (i.e., SCS and CP length) as a physical sidelink control channel (PSCCH)/physical sidelink shared channel (PSSCH) in the carrier, and the transmission bandwidth thereof may be within a (pre)set sidelink BWP (SL BWP). For example, the bandwidth of the S-SSB may be 11 resource blocks (RBs). For example, the PSBCH may span 11 RBs. The frequency position of the S-SSB may be (pre)set. Accordingly, the UE does not need to perform hypothesis detection at a frequency to discover the S-SSB in the carrier.

In the NR SL system, a plurality of numerologies having different SCSs and/or CP lengths may be supported. In this case, as the SCS increases, the length of the time resource in which the transmitting UE transmits the S-SSB may be shortened. Thereby, the coverage of the S-SSB may be narrowed. Accordingly, in order to guarantee the coverage of the S-SSB, the transmitting UE may transmit one or more S-SSBs to the receiving UE within one S-SSB transmission period according to the SCS. For example, the number of S-SSBs that the transmitting UE transmits to the receiving UE within one S-SSB transmission period may be pre-configured or configured for the transmitting UE. For example, the S-SSB transmission period may be 160 ms. For example, for all SCSs, the S-SSB transmission period of 160 ms may be supported.

For example, when the SCS is 15 kHz in FR1, the transmitting UE may transmit one or two S-SSBs to the receiving UE within one S-SSB transmission period. For example, when the SCS is 30 kHz in FR1, the transmitting UE may transmit one or two S-SSBs to the receiving UE within one S-SSB transmission period. For example, when the SCS is 60 kHz in FR1, the transmitting UE may transmit one, two, or four S-SSBs to the receiving UE within one S-SSB transmission period.

For example, when the SCS is 60 kHz in FR2, the transmitting UE may transmit 1, 2, 4, 8, 16 or 32 S-SSBs to the receiving UE within one S-SSB transmission period. For example, when SCS is 120 kHz in FR2, the transmitting UE may transmit 1, 2, 4, 8, 16, 32 or 64 S-SSBs to the receiving UE within one S-SSB transmission period.

When the SCS is 60 kHz, two types of CPs may be supported. In addition, the structure of the S-SSB transmitted from the transmitting UE to the receiving UE may depend on the CP type. For example, the CP type may be normal CP (NCP) or extended CP (ECP). Specifically, for example, when the CP type is NCP, the number of symbols to which the PSBCH is mapped in the S-SSB transmitted by the transmitting UE may be 9 or 8. On the other hand, for example, when the CP type is ECP, the number of symbols to which the PSBCH is mapped in the S-SSB transmitted by the transmitting UE may be 7 or 6. For example, the PSBCH may be mapped to the first symbol in the S-SSB transmitted by the transmitting UE. For example, upon receiving the S-SSB, the receiving UE may perform an automatic gain control (AGC) operation in the period of the first symbol for the S-SSB.

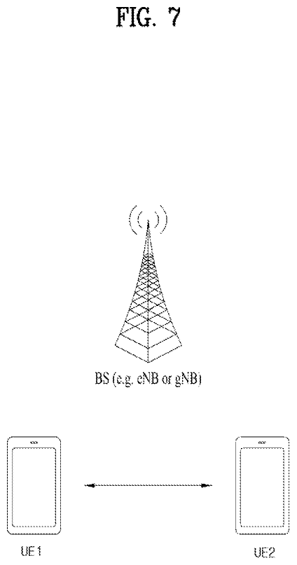

FIG. 7 illustrates UEs performing V2X or SL communication.

Referring to FIG. 7, in V2X or SL communication, the term UE may mainly refer to a user's UE. However, when network equipment such as a BS transmits and receives signals according to a communication scheme between UEs, the BS may also be regarded as a kind of UE. For example, UE 1 may be the first device 100, and UE 2 may be the second device 200.

For example, UE 1 may select a resource unit corresponding to a specific resource in a resource pool, which represents a set of resources. Then, UE 1 may transmit an SL signal through the resource unit. For example, UE 2, which is a receiving UE, may receive a configuration of a resource pool in which UE 1 may transmit a signal, and may detect a signal of UE 1 in the resource pool.

Here, when UE 1 is within the connection range of the BS, the BS may inform UE 1 of a resource pool. On the other hand, when the UE 1 is outside the connection range of the BS, another UE may inform UE 1 of the resource pool, or UE 1 may use a preconfigured resource pool.

In general, the resource pool may be composed of a plurality of resource units, and each UE may select one or multiple resource units and transmit an SL signal through the selected units.

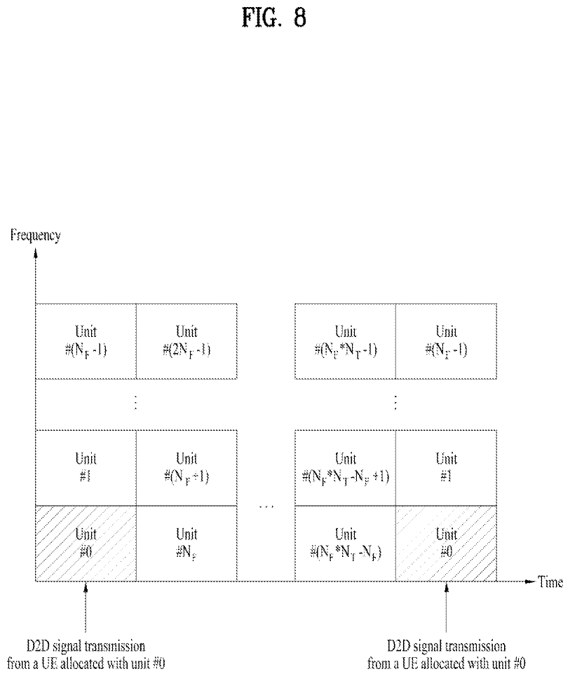

FIG. 8 illustrates resource units for V2X or SL communication.

Referring to FIG. 8, the frequency resources of a resource pool may be divided into N_{F} sets, and the time resources of the resource pool may be divided into N_{T} sets. Accordingly, a total of N_{F}*N_{T} resource units may be defined in the resource pool. FIG. 8 shows an exemplary case where the resource pool is repeated with a periodicity of NT subframes.

As shown in FIG. 8, one resource unit (e.g., Unit #0) may appear periodically and repeatedly. Alternatively, in order to obtain a diversity effect in the time or frequency dimension, an index of a physical resource unit to which one logical resource unit is mapped may change in a predetermined pattern over time. In this structure of resource units, the resource pool may represent a set of resource units available to a UE which intends to transmit an SL signal.

Resource pools may be subdivided into several types. For example, according to the content in the SL signal transmitted in each resource pool, the resource pools may be divided as follows.

(1) Scheduling assignment (SA) may be a signal including information such as a position of a resource through which a transmitting UE transmits an SL data channel, a modulation and coding scheme (MCS) or multiple input multiple output (MIMO) transmission scheme required for demodulation of other data channels, and timing advance (TA). The SA may be multiplexed with SL data and transmitted through the same resource unit. In this case, an SA resource pool may represent a resource pool in which SA is multiplexed with SL data and transmitted. The SA may be referred to as an SL control channel.

(2) SL data channel (physical sidelink shared channel (PSSCH)) may be a resource pool through which the transmitting UE transmits user data. When the SA and SL data are multiplexed and transmitted together in the same resource unit, only the SL data channel except for the SA information may be transmitted in the resource pool for the SL data channel. In other words, resource elements (REs) used to transmit the SA information in individual resource units in the SA resource pool may still be used to transmit the SL data in the resource pool of the SL data channel. For example, the transmitting UE may map the PSSCH to consecutive PRBs and transmit the same.

(3) The discovery channel may be a resource pool used for the transmitting UE to transmit information such as the ID thereof. Through this channel, the transmitting UE may allow a neighboring UE to discover the transmitting UE.

Even when the SL signals described above have the same content, they may use different resource pools according to the transmission/reception properties of the SL signals. For example, even when the SL data channel or discovery message is the same among the signals, it may be classified into different resource pools according to determination of the SL signal transmission timing (e.g., transmission at the reception time of the synchronization reference signal or transmission by applying a predetermined TA at the reception time), a resource allocation scheme (e.g., the BS designates individual signal transmission resources to individual transmitting UEs or individual transmission UEs select individual signal transmission resources within the resource pool), signal format (e.g., the number of symbols occupied by each SL signal in a subframe, or the number of subframes used for transmission of one SL signal), signal strength from a BS, the strength of transmit power of an SL UE, and the like.

Hereinafter, resource allocation in the SL will be described.

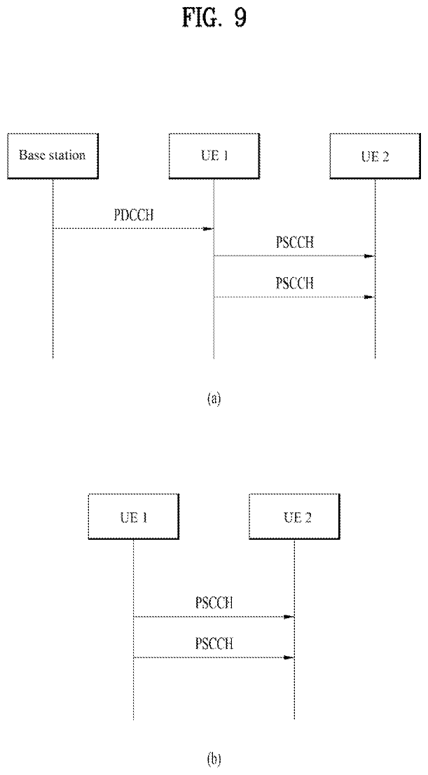

FIG. 9 illustrates a procedure in which UEs perform V2X or SL communication according to a transmission mode. In various embodiments of the present disclosure, the transmission mode may be referred to as a mode or a resource allocation mode. Hereinafter, for simplicity, the transmission mode in LTE may be referred to as an LTE transmission mode, and the transmission mode in NR may be referred to as an NR resource allocation mode.

For example, FIG. 9-(a) illustrates a UE operation related to LTE transmission mode 1 or LTE transmission mode 3. Alternatively, for example, FIG. 9-(a) illustrates a UE operation related to NR resource allocation mode 1. For example, LTE transmission mode 1 may be applied to general SL communication, and LTE transmission mode 3 may be applied to V2X communication.

For example, FIG. 9-(b) illustrates a UE operation related to LTE transmission mode 2 or LTE transmission mode 4. Alternatively, for example, FIG. 9-(b) illustrates a UE operation related to NR resource allocation mode 2.

Referring to FIG. 9-(a), in LTE transmission mode 1, LTE transmission mode 3 or NR resource allocation mode 1, the BS may schedule an SL resource to be used by the UE for SL transmission. For example, the BS may perform resource scheduling for UE 1 through PDCCH (more specifically, downlink control information (DCI)), and UE 1 may perform V2X or SL communication with UE 2 according to the resource scheduling. For example, UE 1 may transmit sidelink control information (SCI) to UE 2 on a physical sidelink control channel (PSCCH), and then transmit data which is based on the SCI to UE 2 on a physical sidelink shared channel (PSSCH).

For example, in NR resource allocation mode 1, the UE may be provided with or allocated resources for one or more SL transmissions of a transport block (TB) from the BS through a dynamic grant. For example, the BS may provide a resource for transmission of the PSCCH and/or PSSCH to the UE using the dynamic grant. For example, the transmitting UE may report the SL hybrid automatic repeat request (HARQ) feedback received from the receiving UE to the BS. In this case, the PUCCH resource and timing for reporting the SL HARQ feedback to the BS may be determined based on an indication in the PDCCH through the BS is to allocate a resource for SL transmission.

For example, DCI may include a slot offset between DCI reception and the first SL transmission scheduled by the DCI. For example, the minimum gap between the DCI scheduling a SL transmission resource and the first scheduled SL transmission resource may not be shorter than the processing time of the corresponding UE.

For example, in NR resource allocation mode 1, the UE may be periodically provided with or allocated a resource set from the BS for a plurality of SL transmissions through a configured grant. For example, the configured grant may include configured grant type 1 or configured grant type 2. For example, the UE may determine a TB to be transmitted in each occasion indicated by a given configured grant.

For example, the BS may allocate SL resources to the UE on the same carrier, and may allocate SL resources to the UE on different carriers.

For example, an NR BS may control LTE-based SL communication. For example, the NR BS may transmit NR DCI to the UE to schedule an LTE SL resource. In this case, for example, a new RNTI for scrambling the NR DCI may be defined. For example, the UE may include an NR SL module and an LTE SL module.

For example, after the UE including the NR SL module and the LTE SL module receives NR SL DCI from the gNB, the NR SL module may transform the NR SL DCI to LTE DCI type 5A, and the NR SL module may deliver LTE DCI type 5A to the LTE SL module in units of X ms. For example, the LTE SL module may apply activation and/or release to the first LTE subframe Z ms after the LTE SL module receives LTE DCI format 5A from the NR SL module. For example, the X may be dynamically indicated using a field of DCI. For example, the minimum value of X may depend on the UE capability. For example, the UE may report a single value according to the UE capability. For example, X may be a positive number.

Referring to FIG. 9-(b), in LTE transmission mode 2, LTE transmission mode 4, or NR resource allocation mode 2, the UE may determine AN SL resource within the SL resources configured by the B S/network or the preconfigured SL resources. For example, the configured SL resources or the preconfigured SL resources may be a resource pool. For example, the UE may autonomously select or schedule a resource for SL transmission. For example, the UE may autonomously select a resource within the configured resource pool to perform SL communication. For example, the UE may select a resource within a selection window by performing a sensing and resource (re)selection procedure. For example, the sensing may be performed on a per sub-channel basis. In addition, UE 1, which has selected a resource within the resource pool, may transmit SCI to UE 2 through the PSCCH, and then transmit data, which is based on the SCI, to UE 2 through the PSSCH.

For example, a UE may assist in selecting an SL resource for another UE. For example, in NR resource allocation mode 2, the UE may receive a configured grant for SL transmission. For example, in NR resource allocation mode 2, the UE may schedule SL transmission of another UE. For example, in NR resource allocation mode 2, the UE may reserve an SL resource for blind retransmission.

For example, in NR resource allocation mode 2, UE 1 may indicate the priority of SL transmission to UE 2 using the SCI. For example, UE 2 may decode the SCI. UE 2 may perform sensing and/or resource (re)selection based on the priority. For example, the resource (re)selection procedure may include an operation of identifying candidate resources in a resource selection window by UE 2, and an operation of selecting, by UE 2, a resource for (re)transmission from among the identified candidate resources. For example, the resource selection window may be a time interval during which the UE selects the resource for SL transmission. For example, after UE 2 triggers resource (re)selection, the resource selection window may start at T1≥0. The resource selection window may be limited by the remaining packet delay budget of UE 2. For example, in the operation of identifying the candidate resources in the resource selection window by UE 2, a specific resource may be indicated by the SCI received by UE 2 from UE 1. When the L1 SL RSRP measurement value for the specific resource exceeds an SL RSRP threshold, UE 2 may not determine the specific resource as a candidate resource. For example, the SL RSRP threshold may be determined based on the priority of the SL transmission indicated by the SCI received by UE 2 from UE 1 and the priority of the SL transmission on the resource selected by UE 2.

For example, the L1 SL RSRP may be measured based on an SL demodulation reference signal (DMRS). For example, one or more PSSCH DMRS patterns may be configured or preconfigured for each resource pool in the time domain. For example, PDSCH DMRS configuration type 1 and/or type 2 may be the same as or similar to the frequency domain pattern of the PSSCH DMRS. For example, the exact DMRS pattern may be indicated by the SCI. For example, in NR resource allocation mode 2, the transmitting UE may select a specific DMRS pattern from among DMRS patterns configured or preconfigured for the resource pool.

For example, in NR resource allocation mode 2, based on the sensing and resource (re)selection procedure, the transmitting UE may perform initial transmission of a TB without reservation. For example, based on the sensing and resource (re)selection procedure, using the SCI associated with a first TB, the transmitting UE may reserve the SL resource for initial transmission of a second TB.

For example, in NR resource allocation mode 2, the UE may reserve a resource for feedback-based PSSCH retransmission through signaling related to previous transmission of the same TB. For example, the maximum number of SL resources reserved by one transmission including the current transmission may be 2, 3, or 4. For example, the maximum number of SL resources may be the same regardless of whether HARQ feedback is enabled. For example, the maximum number of HARQ (re)transmissions for one TB may be limited by configuration or pre-configuration. For example, the maximum number of HARQ (re)transmissions may be up to 32. For example, when the configuration or pre-configuration is not present, the maximum number of HARQ (re)transmissions may be unspecified. For example, the configuration or pre-configuration may be for the transmitting UE. For example, in NR resource allocation mode 2, HARQ feedback for releasing resources not used by the UE may be supported.

For example, in NR resource allocation mode 2, the UE may indicate to another UE one or more sub-channels and/or slots used by the UE, using the SCI. For example, the UE may indicate to another UE one or more sub-channels and/or slots reserved by the UE for PSSCH (re)transmission, using SCI. For example, the minimum allocation unit of the SL resource may be a slot. For example, the size of the sub-channel may be configured for the UE or may be preconfigured.

Hereinafter, sidelink control information (SCI) will be described.

Control information transmitted by the BS to the UE on the PDCCH may be referred to as downlink control information (DCI), whereas control information transmitted by the UE to another UE on the PSCCH may be referred to as SCI. For example, before decoding the PSCCH, the UE may be aware of the start symbol of the PSCCH and/or the number of symbols of the PSCCH. For example, the SCI may include SL scheduling information. For example, the UE may transmit at least one SCI to another UE to schedule the PSSCH. For example, one or more SCI formats may be defined.

For example, the transmitting UE may transmit the SCI to the receiving UE on the PSCCH. The receiving UE may decode one SCI to receive the PSSCH from the transmitting UE.

For example, the transmitting UE may transmit two consecutive SCIs (e.g., 2-stage SCI) to the receiving UE on the PSCCH and/or the PSSCH. The receiving UE may decode the two consecutive SCIs (e.g., 2-stage SCI) to receive the PSSCH from the transmitting UE. For example, when the SCI configuration fields are divided into two groups in consideration of the (relatively) high SCI payload size, the SCI including a first SCI configuration field group may be referred to as first SCI or 1st SCI, and the SCI including a second SCI configuration field group may be referred to as second SCI or 2nd SCI. For example, the transmitting UE may transmit the first SCI to the receiving UE on the PSCCH. For example, the transmitting UE may transmit the second SCI to the receiving UE on the PSCCH and/or the PSSCH. For example, the second SCI may be transmitted to the receiving UE on the (independent) PSCCH, or may be piggybacked together with data and transmitted on the PSSCH. For example, the two consecutive SCIs may be applied for different transmissions (e.g., unicast, broadcast, or groupcast).

For example, the transmitting UE may transmit some or all of the following information to the receiving UE through SCI. Here, for example, the transmitting UE may transmit some or all of the following information to the receiving UE through the first SCI and/or the second SCI:
PSSCH and/or PSCCH related resource allocation information, for example, the positions/number of time/frequency resources, resource reservation information (e.g., periodicity); and/or
SL CSI report request indicator or SL (L1) RSRP (and/or SL (L1) RSRQ and/or SL (L1) RSSI) report request indicator; and/or
SL CSI transmission indicator (or SL (L1) RSRP (and/or SL (L1) RSRQ and/or SL (L1) RSSI) information transmission indicator) (on PSSCH); and/or
MCS information; and/or
transmit power information; and/or
L1 destination ID information and/or L1 source ID information; and/or
SL HARQ process ID information; and/or
new data indicator (NDI) information; and/or
redundancy version (RV) information; and/or
(transmission traffic/packet related) QoS information; e.g., priority information; and/or
SL CSI-RS transmission indicator or information on the number of (transmitted) SL CSI-RS antenna ports;
Location information about the transmitting UE or location (or distance/area) information about a target receiving UE (to which a request for SL HARQ feedback is made); and/or
information about a reference signal (e.g., DMRS, etc.) related to decoding and/or channel estimation of data transmitted on the PSSCH, for example, information related to a pattern of a (time-frequency) mapping resource of DMRS, rank information, antenna port index information.

For example, the first SCI may include information related to channel sensing. For example, the receiving UE may decode the second SCI using the PSSCH DMRS. A polar code used for the PDCCH may be applied to the second SCI. For example, in the resource pool, the payload size of the first SCI may be the same for unicast, groupcast and broadcast. After decoding the first SCI, the receiving UE does not need to perform blind decoding of the second SCI. For example, the first SCI may include scheduling information about the second SCI.

In various embodiments of the present disclosure, since the transmitting UE may transmit at least one of SCI, the first SCI, and/or the second SCI to the receiving UE on the PSCCH, the PSCCH may be replaced/substituted with at least one of the SCI, the first SCI, and/or the second SCI. Additionally/alternatively, for example, the SCI may be replaced/substituted with at least one of the PSCCH, the first SCI, and/or the second SCI. Additionally/alternatively, for example, since the transmitting UE may transmit the second SCI to the receiving UE on the PSSCH, the PSSCH may be replaced/substituted with the second SCI.

Hereinafter, synchronization acquisition by an SL UE will be described.

In TDMA and FDMA systems, accurate time and frequency synchronization is essential. Inaccurate time and frequency synchronization may lead to degradation of system performance due to inter-symbol interference (ISI) and inter-carrier interference (ICI). The same is true for V2X. For time/frequency synchronization in V2X, a sidelink synchronization signal (SLSS) may be used in the PHY layer, and master information block-sidelink-V2X (MIB-SL-V2X) may be used in the RLC layer.

Hybrid Automatic Repeat Request (HARQ) is the combination of FEC and ARQ, and can improve performance by checking whether data received by a physical layer contains an error that cannot be decoded, and requesting retransmission if an error occurs.

In case of sidelink unicast and groupcast, HARQ feedback and HARQ combining in a physical layer may be supported. For example, when an Rx UE operates in resource allocation mode 1 or 2, the Rx UE may receive PSSCH from a Tx UE, and the Rx UE may transmit HARQ-ACK feedback on the PSSCH to the Tx UE using a Sidelink Feedback Control Information (SFCI) format through Physical Sidelink Control Channel (PSFCH).

When side link HARQ feedback is enabled for unicast, in case of a non-Code Block Group (non-CBG) operation, when the Rx UE successfully decodes a corresponding transport block, the Rx UE may generate HARQ-ACK. Then, the Rx UE may transmit the HARQ-ACK to the Tx UE. After the Rx UE has decoded an associated PSCCH targeting the Rx UE, if the Rx UE fails to successfully decode the corresponding transport block, the Rx UE may generate HARQ-NACK. Then, the Rx UE may transmit the HARQ-NACK to the Tx UE.

When side link HARQ feedback is enabled for groupcast, a UE may determine whether to send HARQ feedback based on a Tx-Rx distance and/or RSRP. In case of a non-CBG operation, two kinds of options may be supported.

(1) Option 1: When an Rx UE fails to decode a corresponding transport block after decoding an associated PSCCH, the Rx UE may transmit HARQ-NACK on PSFCH. Otherwise, the Rx UE may not transmit a signal on PSFCH.

(2) Option 2: When an Rx UE successfully decodes a corresponding transport block, the Rx UE may transmit HARQ-ACK on PSFCH. When the Rx UE fails to decode the corresponding transport block successfully after decoding an associated PSCCH targeting the Rx UE, the Rx UE may transmit HARQ-NACK on PSFCH.

In case of mode 1 resource allocation, the time between HARQ feedback transmission on PSFCH and PSSCH may be set (in advance). In case of unicast and groupcast, if retransmission in sidelink is required, it may be indicated to a BS by an in-coverage UE that uses PUCCH. A Tx UE may transmit an indication to a serving BS of the Tx UE in a form such as a Scheduling Request/Buffer Status Report (SR/B SR) rather than a form of HARQ ACK/NACK. In addition, even if the BS does not receive the indication, the BS may schedule a side link retransmission resource to the UE.

In case of mode 2 resource allocation, the time between HARQ feedback transmission on PSFCH and PSSCH may be set (in advance).

Hereinafter, sidelink congestion control will be described.

When a UE determines a sidelink Tx resource by itself, the UE also determines a size and frequency of a resource used by the UE. Of course, due to constraints from a network, etc., using a resource size or frequency of a predetermined level or higher may be limited. However, when all UEs use relatively large resources in a situation that many UEs are concentrated in a specific area at a specific timing, overall performance may be considerably due to mutual interference.

Accordingly, a UE needs to observe a channel situation. If it is determined that an excessive amount of resources are being consumed, it is preferable that the UE takes an operation in the form of reducing its own resource use. In the present specification, this may be defined as Congestion Control (CR). For example, a UE may determine whether the energy measured in a unit time/frequency resource is equal to or higher than a predetermined level, and adjust an amount and frequency of its Tx resource according to a ratio of the unit time/frequency resource from which the energy equal to or higher than the predetermined level is observed. In the present specification, the ratio of the time/frequency resources from which the energy equal to or higher than the predetermined level is observed may be defined as a Channel Busy Ratio (CBR). The UE may measure the CBR with respect to a channel/frequency. Additionally, the UE may transmit the measured CBR to a network/BS.

Distributed Antenna Array for Vehicular Communication

Hereinafter, a communication system based on distributed antenna units and a central antenna unit will be described in detail.

As the number of uses of wireless communication by a user increases and service categories using wireless communication increase, the necessity of supporting higher data rate and higher quality of service (QoS) for a high-speed mobile user than those conventionally provided has emerged. For example, if multiple users desire to watch multimedia content while using public transportation or when multiple passengers in a private vehicle driving on an expressway use different wireless communication services, a mobile communication system needs to support high-quality wireless services for the above users.

This is a new model that has not existed in a conventional wireless communication service model. To support the new model, a mobile communication network needs to be improved to a revolutionary extent or a new system capable of implementing the new model without affecting network infrastructure needs to be designed. As one method for solving the above object, a vehicular MIMO system in which a large-sized antenna array is installed at a vehicle so that the vehicle may receive a high-quality service through large array gain while traveling at a high speed and a central antenna unit of the vehicle relays received data to passengers in the vehicle is under consideration.

As described above, when the large-sized array antenna or a distributed antenna unit system is installed at the exterior of a vehicle and wireless communication between a BS and passengers in the vehicle is relayed therethrough, \textcircled{1} communication performance degradation caused by penetration loss having an average of about 20 dB may be prevented. \textcircled{2} large array gain may be secured by using many reception (Rx) antennas relative to personal portable communication devices, and \textcircled{3} Rx diversity is easily obtained because the distance between Rx antennas is easily secured.

Due to the above characteristics, vehicular MIMO enables users to receive an excellent communication service relative to a personal portable device without additional investment in infrastructure.

In spite of these advantages, there is no example of installing a large antenna array in a vehicle. Since a vehicle is considerably expensive equipment relative to an existing personal portable communication device, it is not easy to improve and upgrade the vehicle. Further, since the vehicle should satisfy more requirements including design concept and an aerodynamic structure in addition to communication performance, it is not easy to install the large antenna array that limits the design of the vehicle in terms of aesthetics/aerodynamics. In reality, vehicle manufacturers are using a combination antenna, performance of which deteriorates relative to a single antenna, in order to remove visual inconvenience of an existing antenna.

In this regard, in order to solve spatial limitations of the large array antenna, installation of a distributed antenna array system at a vehicle has been considered to implement an arrayed antenna system not through a single array but through multiple arrays.

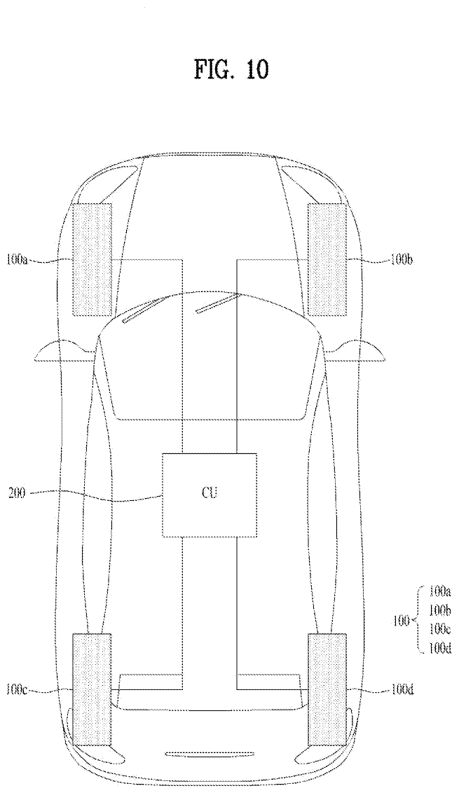

FIG. 10 is a diagram for explaining a distributed antenna unit system provided in a V2X vehicle.

Referring to FIG. 10, a vehicular communication device 10 may include a plurality of distributed antenna units (DUs) 100, and a central antenna or central antenna unit (CU) 200 controlling the plurality of DUs.

The plurality of DUs 100 may be connected to the CU 200 by wire. Alternatively, the plurality of DUs 100 may be connected to the CU 200 wirelessly. Alternatively, the plurality of DUs 100 may transmit signals to an external device through a mobile communication network. Here, the external device may include at least one of a mobile terminal, another vehicle, or a server, located outside the vehicle.

Each of the plurality of DUs 100 may be attached to or disposed at a vehicle body in a distributed manner. For example, each of the plurality of DUs may be distributedly attached to a portion of at least one of a hood, a roof, a trunk, a front windshield, a rear windshield, or a side mirror of the vehicle body. Alternatively, each of the plurality of DUs 100 may be attached to a portion of at least one of the hood, the roof, the trunk, the front windshield, the rear windshield, or the side mirror of the vehicle body facing the sky. Alternatively, each of the plurality of DUs 100 may be attached to a portion of at least one of the hood, the roof, the trunk, the front windshield, the rear windshield, or the side mirror of the vehicle body in a direction opposite to a direction toward the ground.

Each of the plurality of DUs 100 has excellent transmit/receive power performance as each DU is positioned at an upper end of the vehicle body. In addition, a MIMO system may be implemented due to a plurality of array antennas included in each of the plurality of DUs 100. When such a MIMO system is implemented, communication capacity (e.g., communication data capacity) is increased.

The plurality of DUs 100 may include a first DU 100a, a second DU 100b, a third DU 100c, and a fourth DU 100c.

According to an embodiment, the plurality of DUs 100 may include 2, 3, 5 or more DUs. Meanwhile, each of the plurality of DUs 100 may receive a reception signal from the same external device through different frequency bands.

For example, the plurality of DUs 100 may include the first DU 100a and the second DU 100b. The first DU 100a may receive an Rx signal from a first server through a first frequency band. The second DU 100b may receive an Rx signal from the first server through a second frequency band.

Meanwhile, each of the plurality of DUs 100 may receive an Rx signal from the same external device through different time bands.

For example, the plurality of DUs 100 may include the first DU 100a and the second DU 100b. The first DU 100a may receive an Rx signal from the first server through a first time band. The second DU 100b may receive an Rx signal from the first server through a second time band.

The CU 200 may integrally control the plurality of DUs 100. The CU 200 may control each of the plurality of DUs 100. The CU 200 may be connected to the plurality of DUs 100 by wire. The CU 200 may be connected to the plurality of DUs 100 wirelessly. The CU 200 may provide data based on signals received through the plurality of DUs 100 to one or more devices located in the vehicle. For example, the CU 200 may provide data based on signals received through the plurality of DUs 100 to mobile terminals possessed by one or more passengers.

The device located in the vehicle may be a mobile terminal that is located in the vehicle and is possessed by a passenger. The device located in the vehicle may be a user interface device provided in the vehicle. The user interface device is a device for communication between the vehicle and a user. The user interface device may receive a user input signal and provide information generated from the vehicle to the user. The vehicle 100 may implement a user interface (UI) or user experience (UX) through the user interface device.

The user interface device conceptually includes a navigation device, an audio video, navigation (AVN), a center integrated display (CID), a head up display (HUD), and a cluster.

Generally, in a functional/hierarchical aspect of communication, a terminal or a user (or a UE) includes a remote radio head (RRH) (including an RF entity and an analog-to-digital converter (ADC)/digital-to-analog converter (DAC)), a modem (including PHY, MAC, RLC, PDCP, RRC, and NAS layers), and an application processor (AP). The function of a part named DU in the vehicular distributed antenna system may be considered in various ways according to a DU-CU function sharing scenario. That is, the remote unit (RU) or the DU may generally serve only as an antenna (RF or RRH) module among the functions/layers of the UE but additionally assign a portion of not only the RF function but also the functions of the UE to each DU to perform specific processing and combine signals processed by the DU with signals of the CU.

Therefore, in the case of the vehicle antenna system or the vehicular distributed antenna system, the level of difficulty of RF implementation may be reduced (according to the DU-CU implementation scenario) or implementation gain of resolving a DU-CU cabling issue may be obtained, by properly distributing and allocating functional/hierarchical modules of a UE to the DUs and the CU. For example, 4 different implementation options may be broadly considered as follows, depending on how many functional/hierarchical modules of the UE are distributed in the DU.

Implementation options for a distributed antenna system (DAS) may be classified into 4 groups according to “level of distribution function of DU”, and a reference model of each implementation option is described below.

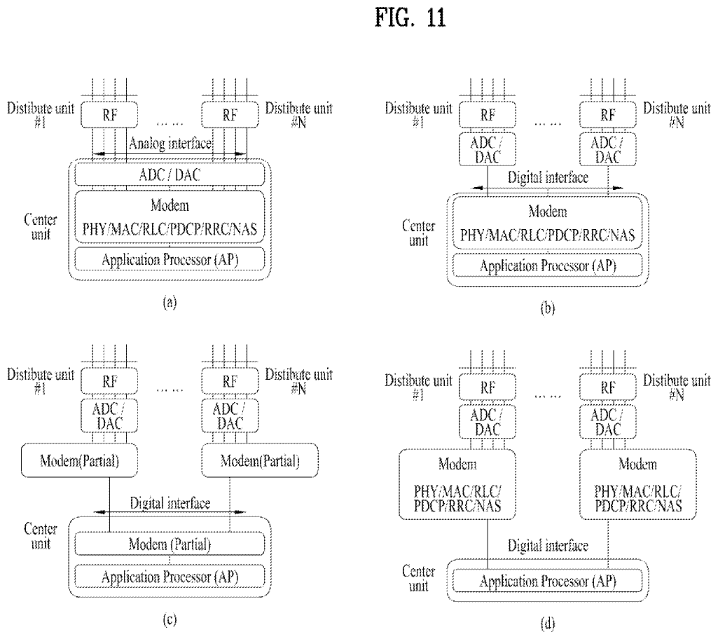

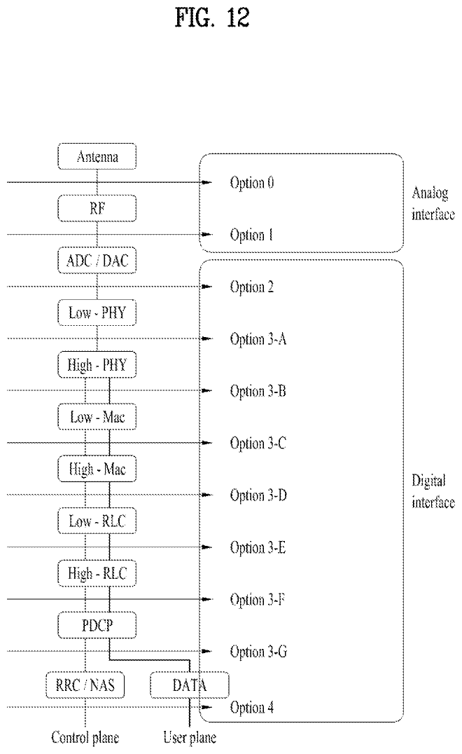

FIGS. 11 and 12 are diagrams for explaining implementation options for a DAS.

The implementation options for the DAS may include Option 1, Option 2, Option 3, and Option 4.

Referring to FIG. 11(a), as a reference model corresponding to Option 1, a DU may include only an RF module. In Option 1, an analog interface between a distribution unit (or a distributed antenna unit) (DU) and a central unit (or a central antenna unit) (CU) is considered. In relation to the analog interface, conversion to an intermediate frequency (IF) band may also be considered.

Specifically, in Option 1, only an RF module is distributed to each DU, and an analog signal may be transmitted from each DU to a CU using an analog interface. Before transmitting the analog signal, the distributed RF module may convert a signal (or an Rx signal) into an IF band signal to reduce cabling loss.

Referring to FIG. 11(b), as a reference model corresponding to Option 2, each DU may include an ADC, a DAC, and an RF module (or RF entity).

Additional functional blocks for controlling automatic gain control (AGC) and automatic frequency control (AFC) deployed individually may be included or required in each DU. The additional functional blocks may be implemented at the DU side in a parallel and distributed manner or at the CU side in a centralized manner. A digital interface may be used or adopted between each DU and the CU.

Referring to FIG. 11(c), as a reference model corresponding to option 3, each DU may include an RF entity, an ADC/DAC, and a partial modem stack (L1/L2). For example, the function of physical layer operation (or physical layer and MAC layer operation) of a modem may be implemented in each DU using the RF entity and the ADC/DAC, and the remaining functions of the modem may be implemented in the CU. In the case of Option 3, a digital interface between each DU and the CU may be used.

Referring to FIG. 11(d), as a reference model corresponding to Option 4, each DU may include an RF entity, an ADC/DAC, and a modem (all modem functions). Signals processed by an individual modem in each DU may be transmitted to a CU (application processor (AP)) via a digital interface.

Table 5 summarizes the contents of the above options.

TABLE 5

| | Description |
|---|---|
| Option 1 | Only RF modules are distributed. Analog interface between |
| | distributed unit and center unit is considered. |
| | * For this interface, conversion to IF (Intermediate |
| | Frequency) bands also can be considered |
| Option 2 | ADC/DAC and RF entities are distributed. Digital interface |
| | between distributed unit and center unit is considered. |
| Option 3 | Partial L1/L2 modem stacks, ADC/DAC and RF entities are |
| | distributed. Digital interface between distributed unit |
| | and center unit is considered. |
| Option 4 | Entire modem stacks and RF entities are distributed. |
| | Digital interface between distributed unit and center |
| | unit is considered. |

Options 1, 2 and 4 above may have characteristics and advantages/disadvantages as shown in Table 6 below.

TABLE 6

| | |
|---|---|
| Option 0: | Only antennas are in the DU and the other functionalities are in the CU. |
| Antenna-RF | Extending the (copper) cabling between the antenna and RF unit is the |
| split | most common solution when the antenna and RF unit are not in the same |
| | place or one RF unit is designed to drive multiple antennas. Since RF |
| | signal is attenuated in the cable, the length of the cable, i.e. the distance |
| | between the remote antenna and the central unit, has a big impact on the |
| | radio performance. This should be taken into consideration in particular |
| | when FR2 band are used for vehicular communication. Instead of passive |
| | antenna, amplifier can be built into the antenna to compensate the cable |
| | loss. This is considered as part of option 1. |
| | Benefits: Passive antenna has less demand on installation space and it is |
| | flexible to mount. The complexity of remote unit is the lowest among all |
| | options. |
| | Cons: Radio performance is impacted by cable length. As the cable loss |
| | scales with the frequency this gets more critical the higher the carrier |
| | frequency, e.g. at FR2 band. Number of cables linearly increases with the |
| | number of MIMO ports at each panel. Implications of analogue |
| | beamforming in FR2 unclear. |
| Option 1: | Antennas and RF are in the DU and the other functionalities are in the |
| RF-PHY | CU. RF signals from different DUs can be combined at CU. |
| split (Analog | The cable loss can be reduced when the RF signal is converted to |
| interface) | intermediate frequency band. However, the cable length remains as a |
| | limitation in the system design. One more advantage of the frequency |
| | converter is in the multi-panel MIMO scenario. With the frequency |
| | converter, multiple streams from one MIMO panel can be frequency |
| | multiplexed and transferred in one cable. |
| | Benefits: Less cable loss if intermediate frequency conversion is applied. |
| | Possible to multiplex the MIMO stream from the same panel. |
| | Cons: Radio performance is impacted by cable length. |
| Option 2: | Antennas, RF and ADC/DAC are in the DU and the other functionalities |
| RF + ADC/DAC - | are in the CU. Moving ADC/DAC to the remote unit enables the digital |
| PHY split | transmission between CU and DU. In the option, time-domain I/Q |
| (Digital | samples are transmitted via interface between CU and DU. Within the |
| interface) | size of a vehicle the cable length and the distance between CU and DU is |
| | no more the bottleneck for the system design. Both copper and fiber |
| | solution can be used for the cabling. However, the capability of current |
| | copper cable might be critical for a multi-panel MIMO system. In |
| | addition, if FR2 is applied in the future and more than 100 MHz is |
| | available for V2X communication, fiber might be the only solution for |
| | this option. |
| | Benefits: Not limited by cable length. Possible to multiplex the MIMO |
| | streams from the same panel. Joint processing for the signal from/to |
| | different DUs in physical layer operation can be supported efficiently. |
| | (e.g., joint MIMO equalization, LLR combining) Specifically, when |
| | channel decoding is performed in CU, combining gain is achieved. In |
| | addition, multiple DUs can be utilized to gain the selection diversity, or |
| | redundant/duplicated packet TX/RX |
| | Cons: The throughput requirement between CU and DU increases |
| | linearly with the number of bands, bandwidth per band, and number of |
| | antennas at each DU. Eventually increased cost due to fiber solution. The |
| | cost of fiber solution increases with the throughput demand on CU/DU |
| | interface. Interface between CU and DU need to be standardized. (CPRI |
| | as reference) |
| Option 3: | Several sub-options with different split of protocol stack layers can be |
| Intra- | considered. In these sub-options of Option 3, multiple DUs can be |
| modem | utilized to gain the selection diversity, or to transmit/receive |
| function | redundant/duplicated packets. |
| split | If the functions are split to the DUs, it is still possible to have a direct |
| | physical or logical link between the DUs which can enable the direct |
| | coordination between DUs. However, such link will bring additional |
| | overhead and complexity to the system. In the remaining part of report, |
| | we always refer to a split without direct connection between DUs if it is |
| | not specified in the text. |
| | Note: To comply with the 3GPP communication standards, for some of |
| | the option 3 CU/DU functions splits coordination of different functions |
| | across DUs is required. |
| Option 4: | In this split option, application is in the CU only. NAS, RRC, PDCP, |
| Split into | RLC, MAC, physical layer and RF are in the DU, thus the entire control |
| individual UEs | and user plane are in the DU. In 3GPP topology, each DU is interpreted |
| | as an individual UE. Each UE may have different UE ID, and the vehicle |
| | with multiple DUs is regarded as a group of UEs, or multiple UEs. This |
| | could be an attribute which differentiates Option 4 from the other options |
| | (Option 1, 2 and 3). |
| | No coordination is required between the DUs in the communication layer. |
| | However, coordination on the application layer is still possible, or in |
| | some cases is required. |
| | Benefits: Each remote unit can be updated and replaced individually. It |
| | is possible to integrate with other active devices or sensors in the vehicle. |
| | It is possible to use a common interface/bus to communicate with the |
| | central application unit. |
| | Cons: Cost of multiple UE. Each UE need individual space. Less |
| | efficient due to leak of coordination. DUs (UEs) might compete for radio |
| | resource and might even interfere with each other. |

Meanwhile, in the case of Option 3 of Table 5 and/or Table 6, various modified models may be considered depending on how functions/stacks in a modem are split between the CU and DUs.

Referring to FIG. 12, Option 3 may include modified models of Option 3-A, Option 3-B, Option 3-C, Option 3-D, Option 3-E, Option 3-F, and Option 3-G. Each of the modified models has the following characteristics and advantages/disadvantages.

1) Option 3A: Low PHY—High PHY Split

In Option 3A, a DU may include an RF and part of a physical layer function (=Low-PHY). A CU may include higher layers and the other part of the physical layer function (=High-PHY). Functional split into High-PHY and Low-PHY described above may be modified in several ways. For example, Low-PHY may include fast Fourier transmission (FFT)/inverse fast Fourier transform (IFFT), CP removal/addition, and/or MIMO (de)coding. High-PHY may include channel coding (or channel decoding).
Benefits: \textcircled{1} Throughput demand between the CU and the DU are much lower than in Option 2. \textcircled{2} Only a part of information related to a specific UE (vehicle) may be transmitted or exchanged between the CU and the DU through a specific PHY process (e.g., FFT/IFFT and/or CP removal/addition). \textcircled{3} In this split (Low PHY-High PHY split), joint processing for signals from or to different DUs in physical layer operation may be efficiently supported.
Disadvantages: \textcircled{1} complexity of the RU or the DU may be increased. \textcircled{2} An interface between the CU and the DU needs to be defined or standardized,

2) Option 3B: PHY—MAC Split

For option 3B, higher layer and MAC functions are performed in the CU. All of physical layer operation may be supported or performed in the DU. For example, HARQ operation of the same MAC PDU for multiple DUs may be supported in a centralized manner. In this case, a throughput demand may be further reduced as compared to Option 3A. Only MAC package and MAC layer signaling may be transmitted between the CU and the DU.
Benefits: Throughput between the CU and the DU is greatly lowered.
Disadvantages: Since there is no PHY layer coordination between a plurality of DUs, the efficiency of MIMO gain may be reduced.

3) Other Option 3X (Option 3-C, Option 3-D, Option 3-E, Option 3-F, and Option 3-G)

In the case of CU/DU split (or CU/DU functional split) in a higher layer, throughput demand between the DU and the CU may be further reduced. The efficiency of multi-antenna coordination and MIMO gain at the same timing may be decreased due to a tradeoff. Latency caused by transmission between the CU and the DU may cause performance degradation because scheduling, radio resource measurement (RRM), and HARQ/ARQ processes are affected by additional delay. However, such degradation may be insignificant in terms of the UE.

Synchronization Method between DUs in Vehicular Distributed Antenna System

According to 3GPP RAN4 UE requirements, the UE needs to satisfy clock frequency error requirements and Tx timing alignment error (TAE) requirements for frequency/time synchronization as shown in Table 7 below.

TABLE 7

| Frequency | For UE(s) supporting UL MIMO, the basic measurement interval of modulated |
|---|---|
| error for | carrier frequency is 1 UL slot. The mean value of basic measurements of UE |
| UL MIMO | modulated carrier frequency at each transmit antenna connector shall be accurate |
| (TS | to within ±0.1 PPM observed over a period of 1 ms of cumulated measurement |
| 38.101-1, | intervals compared to the carrier frequency received from the NR Node B. |
| section | |
| 6.4D.1) | |
| Frequency | The UE modulated carrier frequency for NR V2X sidelink transmissions in Table |
| error for | 5.2E-1, shall be accurate to within ±0.1 PPM observed over a period of 1 ms |
| V2X (TS | compared to the absolute frequency in case of using GNSS synchronization |
| 38.101-1, | source. The same requirements applied over a period of 1 ms compared to the |
| section | carrier frequency received from the gNB or V2X synchronization reference UE in |
| 6.4E.1) | case of using the gNB or V2X synchronization reference UE sidelink |
| | synchronization signals. |
| | For NR V2X UE supporting SL MIMO, the UE modulated carrier frequency at |
| | each transmit antenna connector shall be accurate to within ±0.1 PPM observed |
| | over a period of 0.5 ms in case of using GNSS synchronization source. The same |
| | requirements applied over a period of 0.5 ms compared to the relative frequency |
| | in case of using the NR gNode B or V2X UE sidelink synchronization signals. |
| | If the UE transmits on one antenna connector at a time, the requirements for |
| | single carrier shall apply to the active antenna connector. |
| TAE for | For UE(s) with multiple transmit antenna connectors supporting UL MIMO, this |
| UL MIMO | requirement applies to frame timing differences between transmissions on |
| case in | multiple transmit antenna connectors in the closed-loop spatial multiplexing |
| FR1 (TS | scheme. |
| 38.101-1, | The time alignment error (TAE) is defined as the average frame timing difference |
| section | between any two transmissions on different transmit antenna connectors. |
| 6.4D.3) | For UE(s) with multiple transmit antenna connectors, the Time Alignment Error |
| | (TAE) shall not exceed 130 ns. |
| TAE for | For a UE with multiple physical antenna ports supporting UL MIMO, this |
| UL MIMO | requirement applies to frame timing differences between transmissions on |
| case in | multiple physical antenna ports in the codebook transmission scheme. |
| FR2 (TS | The time alignment error (TAE) is defined as the average frame timing difference |
| 38.101-2, | between any two transmissions on different physical antenna ports. |
| section | For a UE with multiple physical antenna ports, the Time Alignment Error (TAE) |
| 6.4D.3) | shall not exceed 130 ns. |
| TAE for | For V2X UE(s) with two transmit antenna connectors in SL MIMO or Transmit |
| V2X in | Diversity scheme, this requirement applies to slot timing differences between |
| FR1 (TS | transmissions on two transmit antenna connectors. The Time Alignment Error |
| 38.101-1, | (TAE) shall not exceed 260 ns. |
| section | |
| 6.6) | |

The above UE Tx-related requirements may be applied to each antenna connector or (physical) antenna port of the UE in UL/SL MIMO transmission. When the UE is equipped with a plurality of distributed antennas (or vehicular distributed antennas), a connecting interface/cable between the CU and DU may have uncertainty depending on the characteristics of the interface/cable. Each cable between the CU and DU may have a different line delay generated therein (in particular, when the length of the connecting cable between the CU and DU varies for each DU).

Therefore, a timing difference may occur between a CU and DU and/or between DUs due to a timing delay/offset caused by the interface uncertainty and/or line delay. If it is difficult to internally calibrate the timing difference by the UE implementation, the timing difference may act as a factor that does not satisfy the TAE requirements of RAN4 between antenna connectors or (physical) antenna ports belonging to different DUs included in the UE.

According to the CU-DU function split implementation methods described above, each DU may require individual hardware components (e.g., oscillator, different RF/circuit structure, amplifier, phase shifter, etc.) to implement the UE with distributed antennas. These hardware components may cause timing/frequency offsets between DUs (between antenna connectors, between antenna ports, or between antenna connectors or ports belonging to different DUs) (unlike UEs with the conventional co-located antenna system).

Therefore, when the UE has the vehicular distributed antenna system (that is, when the UE includes a plurality of DUs), it may be important to match frequency and/or time synchronization between DUs (between antenna connectors, between antenna ports, or between antenna connectors or ports belonging to different DUs) in consideration of the above-described timing/frequency delay/offset. That is, to allow the UE with vehicular distributed antennas to satisfy the clock frequency error requirements and Tx timing alignment error requirements defined in current 3GPP RAN4, there is a need to solve the above-described problems for the timing/frequency delay/offset.

Hereinafter, methods of matching frequency/timing synchronization between DUs (between antenna connectors, between antenna ports, or between antenna connectors or ports belonging to different DUs) based on signaling between the DUs will be described in detail.

The antenna or DU may refer to a component corresponding to a physical/logical antenna port, a physical/logical antenna port group, an antenna connector, an antenna panel, an antenna element, etc. Therefore, the following proposals and proposed methods for matching frequency/timing synchronization between antennas or DUs may also be applied between physical/logical antenna ports, between physical/logical antenna port groups, between antenna connectors, between antenna panels, and between antenna elements.

The following methods may be mainly applied to Option 3A (Low PHY—High PHY split) and Option 3B (PHY—MAC split) in Option 3 (Intra-modem function split) among the above-described function split implementation methods. In addition, the methods may be applicable to other function split implementation methods.

The proposed methods will be described with an example in which two DUs (=DU1 and DU2) are connected/interlocked with one CU. However, the two DUs are merely exemplary for convenience of explanation, and the proposed methods may be applied to communication through a plurality of DUs without any restrictions.

(1) Timing Alignment Method 1

The UE may transmit/receive a signal (distributed antenna unit tracking reference signal (DU-TRS)) to match synchronization between DUs (between antenna connectors, between antenna ports, or between antenna connectors or ports belonging to different DUs) in the UE. That is, the UE may measure a timing error/offset value between DUs based on DU-TRS transmission and reception between different DUs (or a plurality of DUs). The UE may perform synchronization between the plurality of DUs (between antenna connectors, between antenna ports, or between antenna connectors or ports belonging to different DUs) based on the measured value in order to align signal transmission and reception timings between the plurality of DUs.

Among a plurality of DUs included in the UE, at least one DU may be predefined or selected as a reference DU. Here, the reference DU may be a DU serving as a synchronization reference among the plurality of DUs when synchronization is performed. The reference DU may be already known and/or promised between the plurality of DUs in the UE. Alternatively, the reference DU may be (re)selected from among the plurality of DUs through signaling between the plurality of DUs or signaling over an interface between the DU and CU (with a long periodicity), and then the selected result may be known to the plurality of DUs.

For example, when the UE has two DUs (DU1 and DU2) (or when the UE has distributed antennas), the UE may transmit a DU-TRS through DU1 and measure the timing at which the corresponding DU-TRS is received at DU2 to calculate a timing offset between DU1 and DU2. That is, the UE may transmit the DU-TRS through DU1 and receive the DU-TRS through DU2. Then, the UE may calculate the timing offset between the timing at which the DU-TRS is transmitted by DU1 and the timing at which the DU-TRS is received by DU2.

Hereinafter, Timing Alignment Method 1-1 and Timing Alignment Method 1-2 will be described in relation to the timing alignment method based on the DU-TRS.

Timing Alignment Method 1-1

According to Timing Alignment Method 1-1, DU2 may directly adjust its timing based on a timing of receiving a DU-TRS from DU1, which is the reference DU. Specifically, DU2 may calculate a timing offset and/or timing error with respect to a timing related to DU1 (e.g., DU-TRS transmission timing) based on the reception timing of the received DU-TRS and then adjust its timing based on the calculated timing offset.

For example, when DU1 is the reference DU, DU2 may detect/decode the DU-TRS transmitted from DU1 and then adjust/correct its own timing by the timing offset, which is measured/calculated based on the detection/decoding. In this case, DU1, which is the reference DU, may need to perform DU-TRS transmission only, whereas DU2 may perform all of the following operations: DU-TRS reception, timing offset calculation, and timing adjustment.

In this case, the timing at which DU2 receives the DU-TRS may be obtained by adding “a propagation delay between DU1 and DU2” and “the timing offset between DU1 (reference DU) and DU2” to “the timing at which DU1 transmits the DU-TRS”. Therefore, DU2 may regard “the propagation delay between DU1 and DU2” as “(the distance between DU1-DU2)/(the speed of light)”. Then, DU2 may obtain the timing offset between DU1 (reference DU) and DU2 from the following equation of “the timing offset between DU1 (reference DU) and DU2=(the timing at which DU2 receives the corresponding DU-TRS)−(the timing at which DU1 transmits the DU-TRS)−((the distance between DU1 and DU2)/(the speed of light))”. Then, DU2 may actually adjust its own Tx/Rx timing by the corresponding timing offset.

In addition, performing, by DU2, detection/decoding based on Timing Alignment Method 1-1 may mean that among the CU-DU function split implementation options, the DU-TRS detection/decoding function is implemented in the DU. The above CU-DU function split implementation option may correspond to Option 3 among the above-described CU-DU function split implementation options or detailed options of Option 3.

Timing Alignment Method 1-2

According to Timing Alignment Method 1-2, DU1, which is the reference DU, may transmit a DU-TRS, and a CU may decode/detect the DU-TRS received by each DU (e.g., DU2), calculate a timing error, and inform DU2 of the calculated timing offset to adjust the timing offset of DU2. In other words, DU1, which is the reference DU, may transmit the DU-TRS, and the CU may calculate a timing at which DU2 receives the DU-TRS and the timing offset related to DU2 and then inform DU2 of the calculated timing offset. In this case, the CU may perform the following operations: detecting/decoding the DU-TRS and calculating the timing offset and then transmit the calculated timing offset to DU2.

As described above, the operations of Timing Alignment Method 1-1 may be allowed when the DU-TRS detection/decoding function is implemented in each of a plurality of DUs. If the DU-TRS detection/decoding function is not implemented in some of the plurality of DUs, DU2 needs to forward the received DU-TRS to the CU over an interface between the CU and DU2. In addition, the CU needs to perform DU-TRS detection/decoding and forward the calculated/measured timing offset between DU1 and DU2 to DU2 via the interface between the CU and DU2. In this case, DU2 may adjust its own Tx/Rx timing by the timing offset received from the CU (generated by the internal interface).

When the timing between DU1 and DU2 is adjusted according to the above method (Timing Alignment Method 1-2), the timing at which the CU receives the DU-TRS (forwarded from DU2) may be obtained by adding “a propagation delay between DU1 and DU2”, “the timing offset between DU1 (reference DU) and DU2”, and “a delay/offset due to the interface between the CU and DU2” to “the timing at which DU1 transmits the DU-TRS”. Thus, if the delay/offset due to the interface between the CU and DU2 is negligible because the delay/offset is capable of being internally calibrated by the UE, or if the UE knows the corresponding delay/offset (because the delay/offset is a fixed/semi-fixed value or an instantaneously measurable value), the UE may calculate the timing offset between the reference DU and DU2 based on the following equation: “the timing offset between DU1 (reference DU) and DU2=(the timing at which DU2 receives the corresponding DU-TRS)−(the timing at which DU1 transmits the DU-TRS)−((the distance between DU1 and DU2)/(the speed of light))”; or “the timing offset between DU1 (reference DU) and DU2=(the timing at which DU2 receives the corresponding DU-TRS)−(the timing at which DU1 transmits the DU-TRS)−((the distance between DU1 and DU2)/(the speed of light))−(the delay/offset due to the interface between the CU and DU2)”, similarly to Timing Alignment Method 1-1.

If the delay/offset due to the interface (e.g., interface between the CU and DU2) is a value that the UE (CU and/or DU2) does not know or a value that the UE is incapable of calibrating, Timing Alignment Method 1-2 may cause degradation compared to Timing Alignment Method 1-1

Timing Alignment Method 1-3

According to Timing Alignment Method 1-3, DU1, which is the reference DU, may receive a DU-TRS transmitted by DU2 and detect/decode the corresponding RS. Then, after calculating a timing offset between DU1 and DU2, DU1 may inform DU2 of the calculated timing offset over an internal interface of the UE (via a CU).

According to Timing Alignment Method 1-3, the reference DU may receive DU-TRSs transmitted by other DUs. Then, the reference DU may calculate the timing of the reference DU and timing offsets with each DU based on the DU-TRSs and then inform each DU of the timing offsets to allow each DU to adjust its own timing. In other words, DU1 may receive the DU-TRS transmitted by another DU, DU2, calculate the timing offset based on the received DU-TRS, and inform DU2 of the calculated timing offset over the internal interface. In this case, the timing offsets with each DU relative to the timing of the reference DU may be calculated in the same or similar way to that described in Timing Alignment Method 1-1. On the other hand, if DU1, which is the reference DU, transmits a DU-TRS as in Timing Alignment Method 1-1 and Timing Alignment Method 1-2 described above, the remaining DUs (or a CU via an interface between the CU and DU) may calculate their own timing offsets and adjust their timings with respect to the timing of the reference DU.

Alternatively, according to Timing Alignment Method 1-3, DU1, which is the reference DU, may provide the timing offsets calculated by DU1 to each DU over an interface between DUs or the interface between the DU and CU. When a direct physical interface between DUs is implemented in the vehicular distributed antenna system, the reference DU may inform each DU of the timing offsets between the reference DU and each DU over the direct physical interface. On the other hand, when the direct physical interface between DUs is not implemented, the reference DU may inform each DU of the timing offsets between the reference DU and each DU, which are calculated by the reference DU, through the CU over the interface between the CU and DU. That is, the interface between the CU and DU may be used twice to provide the timing offsets to each DU in the following order: reference DU->CU ->each DU.

Regarding Timing Alignment Method 1-3, when the DU-TRS detection/decoding function is not implemented in DU1, the following operations may be performed. Specifically, the reference DU needs to provide the DU-TRS transmitted from each DU to the CU over the interface between the DU and CU. After performing DU-TRS detection/decoding, the CU may transfer the calculated/measured timing offset between DU1 and DU2 to DU2 over the interface between the CU and DU.

In the timing alignment methods described above, the operation in which other DUs match or align their timings with respect to the timing of the reference DU has been described. The timing of the reference DU may be the same as the timing of the corresponding DU. However, for Timing Alignment Method 1-2 and/or Timing Alignment Method 1-3, the timing of the reference DU may be defined or used as the fastest or slowest timing among the timings of the DUs, which are measured/calculated by the reference DU (or CU), or the average of the timing of some/all DUs. That is, the timing of the reference DU may also be adjusted to match the reference timing (or the timing of the reference DU). In this case, the reference DU may be interpreted as a DU having the right to determine the reference timing. In addition, the UL timing of the UE may be determined with respect to the reference DU. That is, it may be interpreted to mean that the TA value of the UE is determined based on the reference DU. In addition, it may be interpreted to mean that for DUs except for the reference DU, additional TA values are indicated by the timing offsets (with respect to the reference DU).

When the DU-TRS is defined for timing alignment between DUs, the DU-TRS needs to be implemented such that the UE (each DU if possible) is allowed to transmit and receive the DU-TRS, and implementation of too many functions in the DU should not be required for the DU to transmit/detect/decode the DU-TRS (that is, an increase in the DU implementation complexity/cost should be avoided). That is, it may not be appropriate to use a signal requiring complex transmission/reception operations such as (de)modulation/channel (de)coding, etc. as the DU-TRS. For example, an SRS, a PRS, a sidelink synchronization signal (synchronization sequence and/or PSBCH), and/or a signal with a simple sequence needs to be used as the DU-TRS.

After obtaining timing offset information between DUs from DU-TRS transmission/reception between DUs, the UE needs to correct the timing for each DU based on RF tuning. In this case, the UE may need time to correct the timing for each DU. To guarantee the time, a specific time difference (e.g., one symbol, one slot, etc.) needs to be guaranteed between a DU-TRS transmission/reception time and a first transmission/reception time thereafter.

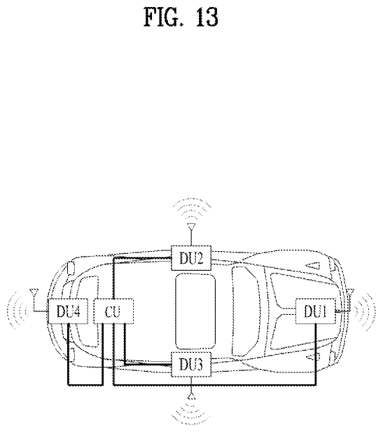

FIG. 13 is a diagram for explaining a UE in a vehicle equipped with distributed antennas.

When the UE is incapable of securing the 360-degree coverage due to the influence of the UE's self-blockage, the UE may use vehicular distributed antennas to improve the coverage by arranging different antennas (or DUs) to (mainly) cover different directions, unlike existing handheld UEs.

Referring to FIG. 13, the distributed antenna may be disposed on each of the front bumper, right door, left door, and rear bumper of the vehicle. In this case, DU1 on the front bumper of the vehicle may be configured to cover 90 degrees in front of the vehicle, DU 2 and DU 3 on both doors may be configured to cover 90 degrees on the left and right, respectively, and DU4 on the rear bumper may be configured to cover 90 degrees in rear of the vehicle.

When the areas covered by each DU are spatially separated as described above, DU-TRS transmission and reception between DUs may not be normally performed. That is, it may be difficult for DU4 to receive a DU-TRS transmitted by DU1, which is the reference DU, and DU4 may not normally match its timing with respect to the timing of DU1. In this case, some DUs that are spatially adjacent to the reference DU, DU1 or some DUs whose coverage overlaps with DU1 may primarily match their timings with the reference DU. For DUs (=DU_remain) that do not match their timings with the reference DU in the primary timing alignment, one/some of the DUs matching their timings during the primary timing alignment may become a new reference DU, and then the DUs may secondarily perform signaling between DUs (DU-TRS transmission and reception) for timing alignment with the DUs in DU_remain. If there are DUs that do not perform DU-TRS transmission and reception even in the secondary timing alignment, the same operation may be repeated to perform third/fourth timing alignment. In other words, DU1 may perform the primary timing alignment with DU2 and/or DU3 whose coverage overlaps with DU1, and DU2 and/or DU3 may transmit a DU-TRS as the new reference DU to perform the secondary timing alignment with DU4.

As described above, the timing alignment between DUs with multiple steps/orders may allow timing alignment between DUs having different covering areas, but there may be a difference in timing alignment between DUs whose timings are aligned with the reference DU through the primary timing alignment and DU_remain DUs whose timings are aligned through the secondary timing alignment. In addition, even if a DU matches its timing in the primary timing alignment, the DU may not perfectly align the timing with the reference DU due to hardware impairment. In this case, DUs (DU_remain) whose timings are aligned through the secondary timing alignment based on the new reference DU may have a relatively large timing error. Considering this situation, DU1 may align its own timing in the secondary timing alignment by receiving the DU-TRS transmitted by DU2 and/or DU3.

In the timing alignment between DUs with multiple steps/orders described above, signaling between DUs, timing offset calculation, exchange of information on a timing offset between DUs (between the DU and CU), which are applied at each step/order, may be performed identically or similarly to Timing Alignment Method 1-1, Timing Alignment Method 1-2, and/or Timing Alignment Method 1-3.

(2) Timing Alignment Method 2.

In Timing Alignment Method 1, it is described that timing alignment between DUs is performed based on signaling between multiple DUs located in one UE. On the other hand, according to Timing Alignment Method 2, information on a timing offset between DUs in a UE with distributed antennas may be obtained/calculated based on signaling between the UE and BS. Depending on communication environments (e.g., whether the communication intensity with the BS is higher than a predetermined threshold, whether the UE is in the coverage of the BS, etc.), the UE may perform timing alignment between multiple DUs by applying at least one of Timing Alignment Method 1 and Timing Alignment Method 2.

Timing Alignment Method 2-1

According to Timing Alignment Method 2-1, the UE may transmit a UL signal/channel (e.g., PUCCH, PUSCH, SRS, etc.) and/or a DU-TRS in each DU, and the BS may receive the UL signal/channel. The BS may calculate a difference (=t_gap_DU1, t_gap_DU2, . . . ) between the timing (e.g., subframe) of the BS and the timing at which the UL signal/channel (or DU-TRS) actually arrives (is received) for each DU. The BS may i) inform the UE (each DU and/or the CU) of the timing offset (e.g., t_gap_DU1) of each DU or ii) inform the UE (DU1 and/or DU2) of a timing offset or time gap difference (e.g., t_gap_DU1−t_gap_DU2), which is a difference between times at which signals transmitted from each DU are received with respect to a specific DU (e.g., reference DU or DU1). Such information may be included in a DL signal/channel (e.g., PDCCH, PDSCH, etc.) transmitted by the BS to the UE and then transmitted. In the operation of i) described above, the UE may use a plurality of DUs to receive information on a set of time gaps: {t_gap_DU1, t_gap_DU2, . . . }. Based on information on the set of time gaps, the reference DU or CU may inform timing offsets, which are the differences between the time gap of the reference DU (t_gap value=t_gap_reference DU) and the time gaps of other DUs, over an interface between DUs or an interface between the DU and CU.

For example, when DU1 is the reference DU, DU1 may receive the information on the set of time gaps ({t_gap_DU1, t_gap_DU2, . . . }) from the BS, DU1 may inform DU2 of the first timing offset (t_gap_DU1−t_gap_DU2) over the interface between DUs (or the interface between the DU and CU) in the following order: DU1->CU->DU2. In this case, DU2 may adjust its own timing based on the first timing offset. On the other hand, when the BS informs the UE of the timing offset value between DUs according to the method of i) and/or ii), the UE may use the offset to improve the accuracy of UE positioning calculation (if the UE calculates its own location).

When a timing offset/error between DUs is measured/calculated based on signaling between the UE and BS (that is, when t_gap_DU1 and t_gap_DU2 are measured/calculated or when the time gap difference (t_gap_DU2−t_gap_DU1) is calculated), the measured/calculated value may be obtained based on \textcircled{1} an air interface propagation delay between DUi (=i-th DU) and the BS (or a difference between delays of different DUs); \textcircled{2} a timing offset/delay due to hardware impairment for each DU (or a difference between offsets/delays of different DUs); and/or \textcircled{3} a timing offset/delay due to the interface offset/delay of each DU (or a difference between offsets/delays of different DUs). However, it may be difficult to identify how much each of \textcircled{1} to \textcircled{3} affects the measured/calculated values of t_gap_DU1 and t_gap_DU2 or the difference between the two values (=t_gap_DU2−t_gap_DU1).

In other words, t_gap_DUi, which is the timing offset/delay between the i-th DU (DUi) and the BS may be represented by the sum of air_delay_i of \textcircled{1}, DU_offset_i of \textcircled{2}, and interface_offset_i of \textcircled{3} (that is, t_gap_DUi=air_delay_i+DU_offset_i+interface_offset_i). In this case, the timing offset between two different DUs (e.g., DUi and DUj) may be expressed or calculated in the form of t_gap_DUi−t_gap_DUj=(air_delay_i−air_delay_j)+(DU_offset_i−DU_offset_j)+(interface_offset_i−interface_offset_j). The timing offset caused by implementation problems and/or hardware impairment of the UE with distributed antennas (compared to the UE with co-located antennas) is the last two terms in the above equation: ((DU_offset_i−DU_offset_j)+(interface_offset_i−interface_offset_j)).

As in the proposed method, when the timing offset between DUs is corrected based on t_gap_DUi and t_gap_DUj (or the timing offset (t_gap_DUi—t_gap_DUj)), it may be interpreted as correcting even a difference between propagation delays due to air interfaces between the BS and different DUs. If the propagation delay between the BS and DUi and the propagation delay between the BS and DUj are almost the same, and/or if the difference between air interface propagation delays between the BS and different DUs is negligible because DUi and DUj are very close (that is, air_delay_i−air_delay_j=0), the UE may align the timings of DUs by actual timing offsets between DUs based on the timing offset (t_gap_DUi−t_gap_DUj). In other words, if the propagation delay between the BS and DUi is almost similar to that between the BS and DUj so that they are negligible, the actual timing offset between DUi and DUj may correspond to the above timing offset (t_gap_DUi−t_gap_DUj).

Alternatively, if the UE knows (approximately) \textcircled{3} air_delay_i and air_delay_j (or the propagation delay difference (air_delay_i−air_delay_j)), the UE may consider a value obtained by subtracting the propagation delay difference (air_delay_i−air_delay_j) from the timing gap difference (t_gap_DUi−t_gap_DUj), which is calculated by the UE (or provided by the BS), as the actual timing error/offset between DUs and then adjust the timings of DUs. In this case, air_delay_i and air_delay_j (or the propagation delay difference) may be derived/calculated by the UE based on the distance between DUs in the vehicle and/or the distance between the BS and each DU (or the difference between distances). For example, when the UE knows that the distance difference between each DU and the BS is [x] meter, the UE may consider x/(the light speed) seconds as the propagation delay difference (air_delay_i−air_delay_j) (or as the maximum value of air_delay_i−air_delay_j and then align the timing of DUj by the calculated value (t_gap_DUi−t_gap_DUj−x/(the speed of light)) (if DUi is the reference DU). That is, when the UE knows the propagation delay difference (air_delay_gap) for the difference between air_delay_i and air_delay_j, the UE may adjust the timings of DUi or DUj based on the difference between the timing gap difference (t_gap_DUi−t_gap_DUj) and the propagation delay difference (air_delay_gap).

When the absolute value of the timing gap difference (t_gap_DUi−t_gap_DUj) is less than or equal to the propagation delay difference (air_delay_gap) or the maximum value of air_delay_gap, the UE may not adjust the timings of DUi and/or DUj. In this case, a timing difference between DUs may be interpreted as being caused by a propagation difference between air interfaces rather than a clock difference between DUs and/or timing delays/offsets caused by interfaces.

Timing Alignment Method 2-2

The BS may transmit a DL signal/channel (e.g., PDCCH, PDSCH, TRS, etc.), and the UE may receive the DL signal/channel using a plurality of DUs. The UE may calculate/derive a timing offset between DUs based on a difference between timings at which each DU receives the DL signal/channel. In this case, the UE may inform a CU of the timing at which each DU receives the DL signal/channel through an interface between the CU and DU. To achieve timing alignment between DUs, the CU may inform each DU of a timing offset for each DU (with respect to a reference timing), which is calculated based on the timing of a reference DU (or with respect to the average, maximum, or minimum of the timings of each DU), over the interface between the CU and DU. In other words, each of the plurality of DUs may transmit information on the reception timing of the DL signal/channel to the CU (via the interface between the CU and DU), and the CU may calculate the timing offset for each DU based on the reception timing and reference timing. The CU may provide the calculated timing offset to each DU (via the interface between the CU and DU), and each DU may align its own timing based on the timing offset.

According to Timing Alignment Method 2-2, timing offset information may be obtained or calculated identically or similarly to Timing Alignment Method 2-1 (the method in which the BS receives a UL signal/channel and/or DU-TRS transmitted by the UE and corrects a timing error/offset). Specifically, when a difference between timings at which each DU receives a signal from the BS is measured/calculated, each DU may measure an actual timing offset between DUs (caused by DU hardware impairment and interface delays/offsets) as well as a timing gap including a propagation delay between the BS and UE. That is, the following modeling: t_gap_DUi=air_delay_i+DU_offset_i+interface_offset_i described in the above paragraph may be equally applied. Thus, as described above, when the timing offset between DUs is corrected based on t_gap_DUi and t_gap_DUj (or t_gap_DUi−t_gap_DUj), it may be interpreted as correcting a difference between propagation delays due to air interfaces between the BS and different DUs.

If the propagation delay between the BS and DUi and the propagation delay between the BS and DUj are almost the same, and/or if the difference between air interface propagation delays between the BS and different DUs is negligible because DUi and DUj are very close (that is, air_delay_i−air_delay_j=0), the UE may align the timings of DUs by actual timing offsets between DUs based on the gap difference (t_gap_DUi−t_gap_DUj).

Alternatively, if the UE knows (approximately) air_delay_i and air_delay_j (or the propagation delay difference (air_delay_i−air_delay_j)), the UE may consider a value obtained by subtracting the propagation delay difference (air_delay_i−air_delay_j) from the gap difference (t_gap_DUi−t_gap_DUj), which is calculated by the UE (or provided by the BS), as the actual timing error/offset between DUs. The DUs may adjust their own timings based on a value obtained by subtracting the propagation delay difference (air_delay_i−air_delay_j) from the timing gap difference (t_gap_DUi−t_gap_DUj). In this case, air_delay_i and air_delay_j (or the propagation delay difference) may be derived/calculated by the UE based on the distance between DUs in the vehicle and/or the distance between the BS and each DU (or the difference between distances). In other words, the UE may calculate and estimate the propagation delay difference based on a difference in distance between each of the plurality of DUs and the BS (e.g., a difference between a first distance between DU1 and BS and a second distance between DU2 and BS). For example, when the UE knows that the distance difference between each DU and the BS is [x] meter, the UE may consider x/(the light speed) seconds as the propagation delay difference (air_delay_i−air_delay_j) (or as the maximum value of the propagation delay) and then align the timing of DUj based on a value obtained by subtracting x/(the speed of light) from the timing gap difference (t_gap_DUi−t_gap_DUj) (if DUi is the reference DU). Specifically, when the UE knows the propagation delay difference (air_delay_gap), the UE may adjust the timing of DUi (or DUj) by a difference between the timing gap difference (t_gap_DUi−t_gap_DUj) and the propagation delay difference (air_delay_gap).

When the absolute value of the timing gap difference (t_gap_DUi−t_gap_DUj) is less than or equal to the propagation delay difference (or the maximum value of the propagation delay difference), the UE may not adjust the timing of DUi (and/or DUj). In this case, a timing difference between DUs may be interpreted as being caused by a propagation difference between air interfaces rather than a clock difference between DUs and/or timing delays/offsets caused by interfaces.

In the above proposal, DU-TRS transmission and reception based on signaling over an air interface for timing alignment between DUs is described. However, the UE with distributed antennas may have a (wired) interface for connecting each DU and the CU. The UE may match the timings between DUs (between antenna connectors, between antenna ports, or between antenna connectors or ports belonging to different DUs) by transmitting and receiving the DU-TRS over the interface between the CU and DU. For example, the CU may periodically transmit a synchronization message (in the form of a message or time stamp on the wired interface) to each DU, and each DU may adjust its clock based on information on the CU's clock received from the CU. In this case, the clock of the CU may be synchronized with a specific DU. The specific DU synchronized with the clock of the CU may be interpreted as the above-described reference DU. Alternatively, the clock of the CU may be set to the fastest, slowest, or average value among the clocks of a plurality of DUs, and the CU may inform each DU of a difference between the clock of the CU and one of the fastest, slowest, or average values among the clocks of the plurality of DUs. Although the timing alignment based on signaling on the (wired) interface between the CU and DU may increase interface implementation complexity, compared to when using signaling on the air interface, the timing alignment based on signaling on the (wired) interface has an advantage in that there is no unnecessary radio resource allocation/consumption for DU-TRS transmission and the DU-TRS transmission is allowed, regardless of interference/noise in air interfaces.

The UE may align the timings of the plurality of DUs by applying at least one of Timing Alignment Method 1 (Timing Alignment Method 1-1, Timing Alignment Method 1-2, and/or Timing Alignment Method 1-3), Timing Alignment Method 2 (Timing Alignment Method 2-1 and/or Timing Alignment Method 2-2), and/or the timing alignment method based on signaling on the (wired) interface between the CU and DU. For example, the UE may align the timings of the plurality of DUs by periodically changing the timing alignment method. Alternatively, the UE may align the timings of the plurality of DUs by applying one of the Timing Alignment Method 1 and the Timing Alignment Method 2 depending on whether signal transmission and reception with the BS is smoothly performed.

It is obvious that each of the examples of the proposed methods may also be included as one implementation method of the present disclosure, and thus each example may be regarded as a kind of proposed method. The present disclosure is not limited to communication between UEs. That is, the present disclosure may be applied to UL or DL communication, and in this case, the proposed methods may be used by the BS, the relay node, etc. In addition, it may be regulated that information on whether the proposed methods are applied (or information on rules related to the proposed methods) needs to be transmitted from a BS to a UE or from a transmitting UE to a receiving UE in a predefined signal (e.g., a physical layer signal, a higher layer signal, etc.). Various embodiments of the present disclosure may be combined with each other.

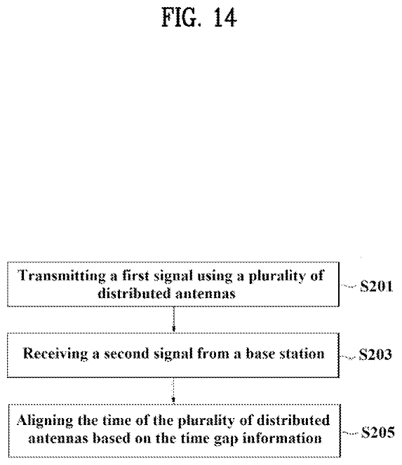

FIG. 14 is a diagram for explaining a method in which a UE aligns timings of a plurality of distributed antennas.

In the following description, it is assumed that the plurality of distributed antennas include a first distributed antenna and a second distributed antenna, and the first distributed antenna is a reference distributed antenna, for convenience of description. The first distributed antenna and the second distributed antenna may correspond to DU1 and DU2, respectively.

Referring to FIG. 14, the UE may transmit a first signal on the plurality of distributed antennas (201). The UE may simultaneously transmit the first signal on the plurality of distributed antennas, and each of the plurality of distributed antennas may transmit the first signal based on its own timing.

The first signal may be a UL signal or a DU-TRS, which is a separate signal for aligning timings of the plurality of distributed antennas. When the first signal is the UL signal, the first signal may be a PUSCH, a PUCCH, or an SRS transmitted on transmission resources allocated by the BS.

Next, the UE may receive a second signal from the BS (S203). The second signal may be a PDCCH, a PDSCH, or a TRS (e.g., DMRS, CSI-RS, etc.), which is a DL signal of the BS. The second signal may include information on time gaps required for the timing alignment of the plurality of distributed antennas obtained based on reception of the first signal. For example, when it is determined based on capability information previously provided by the UE that the UE includes the plurality of distributed antennas, the BS may include the time gap information in the second signal in response to the reception of the first signal.

As described above, the time gap information may be timing information calculated based on a reception timing at which the first signal transmitted on the plurality of distributed antennas is received by the BS. Specifically, the UE may transmit the first signal on each of the plurality of distributed antennas. The BS may receive the first signal transmitted on each of the distributed antennas and calculate the reception timing of the first signal corresponding to each distributed antenna. The BS may generate the time gap information based on the calculated reception timing.

For example, the BS may calculate a difference or gap between the timing of the BS or the timing of a time resource allocated to the first signal (e.g., subframe boundary, slot boundary, etc.) and the reception timing for each of the distributed antennas. The BS may generate the time gap information including the difference or time gap calculated for each of the distributed antennas. That is, the time gap information may include a first difference between the timing of the time resource and the reception timing for a first distributed antenna and a second difference between the timing of the time resource and the reception timing for a second distributed antenna.

Alternatively, the BS may calculate the difference with respect to the first distributed antenna that is a reference distributed antenna among the plurality of distributed antennas. Specifically, the BS may calculate the first difference for the first distributed antenna and calculate the second difference for the second distributed antenna. In this case, the time gap information may include the first difference and a first timing offset (second difference−first difference).

Alternatively, the BS may calculate the difference for the second distributed antenna with respect to a first reception timing, which is a timing at which the first signal transmitted on the first distributed antenna is received. Specifically, when the first reception timing is the timing at which the first signal transmitted on the first distributed antenna is received, and when a second reception timing is a timing at which the first signal transmitted on the second distributed antenna is received, the time gap information may include the first reception timing and a reception offset (second reception timing−first reception timing).

Next, the UE may align the timings of the plurality of distributed antennas based on the time gap information (S205). Each of the plurality of distributed antennas may perform timing alignment based on the time gap information. Each of the plurality of distributed antennas may adjust its Tx/Rx timing based on the first timing offset obtained by subtracting the difference corresponding to the reference distributed antenna from the difference corresponding to each distributed antenna based on the time gap information. Alternatively, each of the plurality of distributed antennas may adjust its Tx/Rx timing based on the first timing offset or reception offset corresponding to each distributed antenna included in the time gap information. The first timing offset may correspond to a difference between the difference corresponding to the reference distributed antenna and the difference corresponding to each distributed antenna.

For example, the second distributed antenna may obtain the second difference corresponding to the second distributed antenna and the first difference corresponding to the first distributed antenna from the time gap information and calculate a value obtained by subtracting the first difference from the second difference (or the first timing offset). The second distributed antenna may adjust its own Tx/Rx timing based on the first timing offset. Alternatively, the second distributed antenna may adjust its own Tx/Rx timing based on the first timing offset or reception offset included in the time gap information.

Alternatively, each of the plurality of distributed antennas may adjust its Tx/Rx timing based on a third timing offset obtained by additionally subtracting the second timing offset from the first timing offset corresponding to each distributed antenna. The second timing offset may be defined as a value obtained by subtracting a propagation delay between the reference distributed antenna and BS from a propagation delay between each distributed antenna and the BS (propagation delay due to an air interface). In this case, each distributed antenna may adjust its own Tx/Rx timing based on the third timing offset obtained by subtracting the second timing offset corresponding to each distributed antenna from the first timing offset corresponding to each distributed antenna.

Alternatively, the second distributed antenna may adjust its own Tx/Rx timing based on a value obtained by subtracting the second timing offset based on the propagation delay from the first timing offset. Here, the second timing offset may be a difference between a first propagation delay, which is a delay due to an air interface between the first distributed antenna and the BS, and a second propagation delay, which is caused by an air interface between the second distributed antenna and the BS. In this case, the second timing offset may correspond to a value obtained by subtracting the first propagation delay from the second propagation delay. As described above, the second timing offset may be predefined or determined based on a difference between a first distance between the first distributed antenna and the BS and a second distance between the second distributed antenna and the BS.

Alternatively, the first distributed antenna, which is the reference distributed antenna, may calculate the first timing offset and/or second timing offset (or difference between the first timing offset and second timing offset) for each distributed antenna. The reference distributed antenna may transmit the calculated first timing offset and/or second timing offset (or difference between the first timing offset and second timing offset) to each distributed antenna through an internal interface (an interface between DUs or an interface between a CU and a DU).

Alternatively, the CU configured to control the plurality of distributed antennas may calculate the first timing offset and/or second timing offset (or difference between the first timing offset and second timing offset) corresponding to each distributed antenna based on the time gap information. The CU may transmit the first timing offset and/or second timing offset (or difference between the first timing offset and second timing offset) for each distributed antenna over the CU-DU interface. In this case, each distributed antenna may adjust its Tx/Rx timing based on the first timing offset and/or second timing offset (or difference between the first timing offset and second timing offset) for itself.

Alternatively, the reference distributed antenna among the plurality of distributed antennas may be predefined or determined based on the time gap information. For example, the UE may select, as the reference distributed antenna, a distributed antenna having the earliest timing among the plurality of distributed antennas, a distributed antenna having the latest timing, or a distributed antenna having a timing closest to the average timing of the plurality of distributed antennas based on the time gap information. In this case, a TA value for the first signal or UL signal may be determined (by the BS) based on the timing of the reference distributed antenna.

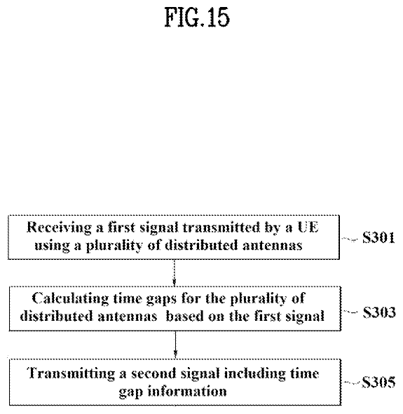

FIG. 15 is a diagram for explaining a method in which a BS transmits a second signal based on a first signal.

Referring to FIG. 15, the BS may receive a first signal transmitted by a UE on a plurality of distributed antennas (S301). The BS may receive the first signal transmitted on each of the plurality of distributed antennas.

The first signal may be a UL signal or a DU-TRS, which is a separate signal for aligning timings of the plurality of distributed antennas. When the first signal is the UL signal, the first signal may be a PUSCH or PUCCH transmitted on transmission resources allocated by the BS.

Next, the BS may calculate time gaps for the plurality of distributed antennas based on the first signal (S303). The time gaps may be information necessary for timing alignment of the plurality of distributed antennas, which is obtained based on reception of the first signal. For example, when it is determined based on capability information previously provided by the UE that the UE includes the plurality of distributed antennas, the BS may include the time gap information in the second signal in response to the reception of the first signal.

As described above, the time gaps may be time offsets between distributed antennas, which are calculated based on a timing at which the first signal transmitted on the plurality of distributed antennas is received by the BS. Specifically, the BS may receive the first signal transmitted on each distributed antenna and calculate the reception timing of the first signal for each distributed antenna. The BS may calculate the time gaps, each corresponding to a differences between a reference timing (a time resource for the UL signal) and the reception timing calculated for each distributed antenna.

For example, the BS may calculate a difference or gap between the timing of the BS or the timing of a time resource allocated to the first signal (e.g., subframe boundary, slot boundary, etc.) and the reception timing for each of the distributed antennas. The BS may generate the time gap information including the calculated time gaps. That is, the time gaps may include a first difference between the timing of the time resource and the reception timing for a first distributed antenna and a second difference between the timing of the time resource and the reception timing for a second distributed antenna.

Alternatively, the BS may calculate the difference or time gap for each of the plurality of distributed antennas with respect to the first distributed antenna that is a reference distributed antenna among the plurality of distributed antennas. Specifically, the BS may calculate the first difference for the first distributed antenna and calculate the second difference for the second distributed antenna. In this case, the BS may calculate the first difference and a first timing offset (second difference−first difference).

Alternatively, the BS may receive information on the reference distributed antenna among the plurality of distributed antennas from the UE or determine the reference distributed antenna based on the reception timing at which the first signal transmitted on each of the plurality of distributed antennas is received. For example, the BS may determine, as the reference distributed antenna, a distributed antenna transmitting the first signal with the fastest reception timing, a distributed antenna transmitting the first signal with the latest reception timing, or a distributed antenna transmitting the first signal with a reception timing closest to the average of the reception timings for the plurality of distributed antennas. In this case, the BS may further include information on the determined reference antenna in the time gap information containing the time gaps.

Alternatively, the BS may configure a TA value for the UE based on the determined reference distributed antenna. For example, considering that the Tx/Rx timing of the reference distributed antenna among the plurality of distributed antennas is not adjusted, the BS may determine a TA value for the first signal or UL signal based on the reception timing of the reference distributed antenna.

Alternatively, the BS may directly calculate the difference for the second distributed antenna with respect to a first reception timing, which is a timing at which the first signal transmitted on the first distributed antenna is received and include the difference in the time gap information. Specifically, when the first reception timing is the timing at which the first signal transmitted on the first distributed antenna is received, and when a second reception timing is a timing at which the first signal transmitted on the second distributed antenna is received, the time gap information may include the first reception timing and a reception offset (second reception timing−first reception timing).

Next, the BS may transmit the second signal including the time gap information containing the time gaps (S305). The second signal may be a PDCCH or a PDSCH, which is a DL signal of the BS.

Communication System Example to Which the Present Disclosure is Applied

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

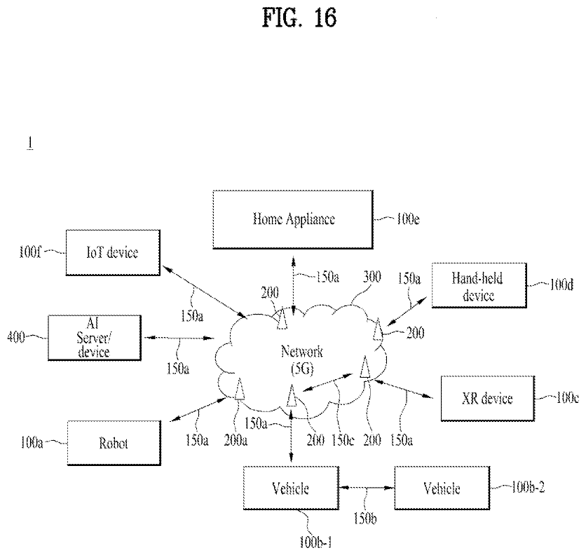

FIG. 16 illustrates a communication system applied to the present disclosure.

Referring to FIG. 16, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

Examples of Wireless Devices to which the Present Disclosure is Applied

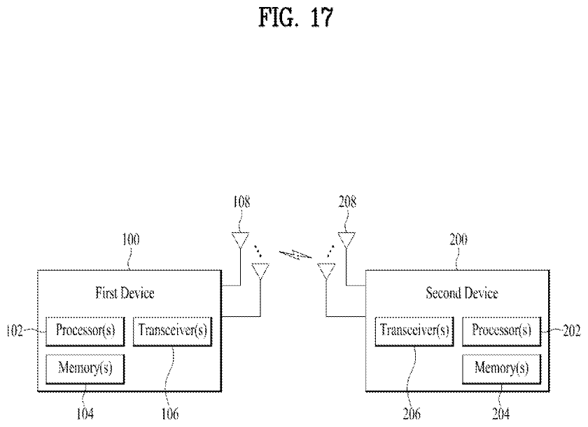

FIG. 17 illustrates a wireless device applicable to the present disclosure.

Referring to FIG. 17, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 16.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

Specifically, the first wireless device 100 or a UE may include the processor(s) 102 connected to the RF transceiver and the memory(s) 104. The memory(s) 104 may include at least one program for performing operations related to the embodiments described above with reference to FIGS. 10 to 15.

The processor(s) 102 may be configured to: control the plurality of distributed antennas including the RF transceiver to transmit a first signal; receive a second signal from a BS; and align timings of the distributed antennas based on the second signal. The second signal may include time gap information for timing alignment between the plurality of distributed antennas. In addition, the processor(s) 102 may be configured to perform the operations described in FIGS. 10 to 15 based on the program included in the memory(s) 104.

Alternatively, a chipset including the processor(s) 102 and memory(s) 104 may be configured. The chipset may include: at least one processor; and at least one memory operably connected to the at least one processor and configured to, when executed, cause the at least one processor to perform operations. The operations may include: controlling a plurality of distributed antennas to transmit a first signal; receiving a second signal from a BS; and aligning timings of the distributed antennas based on the second signal. The second signal may include time gap information for timing alignment between the plurality of distributed antennas. In addition, the operations may include the operations described in FIGS. 10 to 15 based on the program included in the memory(s) 104.

Alternatively, there is provided a computer-readable storage medium including at least one computer program configured to cause at least one processor to perform operations. The operations may include: controlling a plurality of distributed antennas to transmit a first signal; receiving a second signal from a BS; and aligning timings of the distributed antennas based on the second signal. The second signal may include time gap information for timing alignment between the plurality of distributed antennas. In addition, the operations may include the operations described in FIGS. 10 to 15.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Specifically, the second wireless device 200 or a BS may include the processor(s) 202 connected to the RF transceiver and the memory(s) 204. The memory(s) 204 may include at least one program for performing operations related to the embodiments described above with reference to FIGS. 10 to 14.

The processor(s) 202 may be configured to: control the RF transceiver to receive a first signal transmitted by a UE on a plurality of distributed antennas; calculate time gaps between a reception timing of the first signal for each of the plurality of distributed antennas and a timing of a time resource allocated to the first signal; and transmit a second signal including time gap information (information for timing alignment between the plurality of distributed antennas) including the time gaps. The processor(s) 202 may perform the operations described in FIGS. 10 to 15 based on the program included in the memory(s) 204.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

Examples of Wireless Devices to which the Present Disclosure is Applied

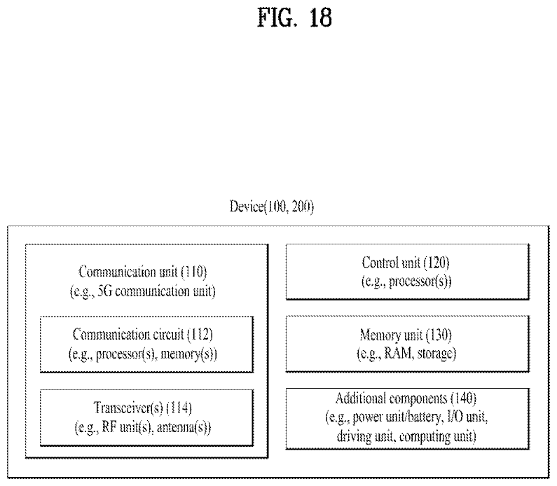

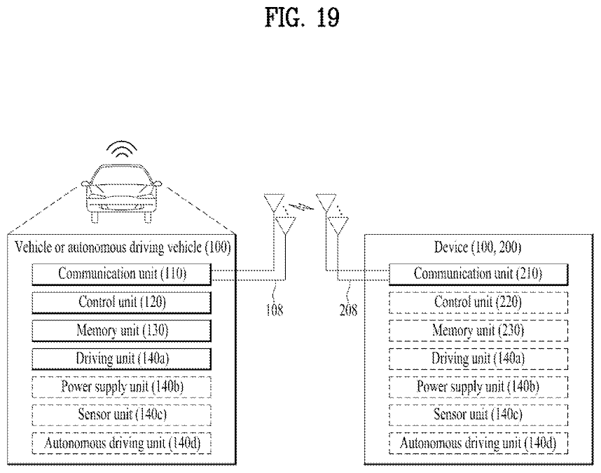

FIG. 18 illustrates another example of a wireless device applied to the present disclosure. The wireless device may be implemented in various forms according to a use-case/service (refer to FIG. 19).

Referring to FIG. 18, wireless devices 100 and 200 may correspond to the wireless devices 100 and 200 of FIG. 17 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 17. For example, the transceiver(s) 114 may include the one or more transceivers 106 and 206 and/or the one or more antennas 108 and 208 of FIG. 17. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 16), the vehicles (100b-1 and 100b-2 of FIG. 16), the XR device (100c of FIG. 16), the hand-held device (100d of FIG. 16), the home appliance (100e of FIG. 16), the IoT device (100f of FIG. 16), a digital broadcast terminal, a hologram device, a public safety device, an MTC device, a medicine device, a fintech device (or a finance device), a security device, a climate/environment device, the AI server/device (400 of FIG. 16), the BSs (200 of FIG. 16), a network node, etc. The wireless device may be used in a mobile or fixed place according to a use-example/service.

In FIG. 18, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Examples of Vehicles or Autonomous Vehicles to which the Present Disclosure is Applied

FIG. 19 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 19, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 18, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). Also, the driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the acquired data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly acquired data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means.

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure.

### INDUSTRIAL APPLICABILITY

The above-described embodiments of the present disclosure are applicable to various mobile communication systems.

1. A method of transmitting and receiving, by a user equipment (UE), signals on a plurality of distributed antennas in a wireless communication system supporting sidelink, the method comprising:
transmitting a first signal to a base station (BS); and
receiving a second signal from the BS,
wherein the first signal is transmitted on the plurality of distributed antennas,
wherein the second signal is received on the plurality of distributed antennas,
wherein the second signal comprises time gap information for timing alignment between the plurality of distributed antennas, and
wherein timings of the plurality of distributed antennas are aligned based on the time gap information.

2. The method of claim 1, wherein the time gap information comprises a time gap between a timing at which the first signal transmitted on each of the plurality of distributed antennas is received and a timing of a time resource allocated to the first signal.

3. The method of claim 1, wherein the time gap information comprises information on a time gap between a reception timing of the first signal related to a reference distributed antenna among the plurality of distributed antennas and a reception timing related to each distributed antenna.

4. The method of claim 3, wherein the timings of the plurality of distributed antennas are aligned based on a value obtained by subtracting a timing offset depending on an air interface with the BS from the time gap, and
wherein the timing offset is obtained by subtracting a propagation delay related to each distributed antenna from a propagation delay related to the reference distributed antenna.

5. The method of claim 4, wherein the timing offset is calculated based on a difference between a distance between the reference distributed antenna and the BS and a distance between each distributed antenna and the BS.

6. The method of claim 3, wherein the timings of the plurality of distributed antennas are aligned with respect to a timing of the reference distributed antenna among the plurality of distributed antennas, and
wherein a distributed antenna having any one of an earliest timing, a latest timing, and an average timing among the timings of the plurality of distributed antennas is determined as the reference distributed antenna based on the time gap information.

7. The method of claim 6, wherein a timing advance (TA) value related to the UE is determined based on a timing of the distributed antenna determined as the reference distributed antenna.

8. The method of claim 6, wherein each of the plurality of distributed antennas is configured to adjust transmission and reception timings based on a timing offset calculated based on the time gap information, and
wherein the timing offset is a difference between the timing of the reference distributed antenna and a timing of each of the plurality of distributed antennas.

9. The method of claim 8, wherein the UE further comprises a center antenna configured to control the plurality of distributed antennas,
wherein the timing offset is calculated by the center antenna and transferred to each of the plurality of distributed antennas over a first interface, and
wherein the first interface is an interface configured to transfer digital information between each of the plurality of distributed antennas and the center antenna.

10. A method of transmitting, by a base station (BS), a second signal to a user equipment (UE) in a wireless communication system supporting sidelink, the method comprising:
receiving a first signal transmitted by the UE on a plurality of distributed antennas;
calculating a time gap between a reception timing of the first signal for each of the plurality of distributed antennas and a timing of a time resource allocated to the first signal; and
transmitting the second signal comprising time gap information comprising the calculated time gap.

11. A user equipment (UE) configured to transmit and receive signals on a plurality of distributed antennas in a wireless communication system supporting sidelink, the UE comprising:
a radio frequency (RF) transceiver; and
a processor connected to the RF transceiver,
wherein the processor is configured to:
control the plurality of distributed antennas including the RF transceiver to transmit a first signal;
receive a second signal from a base station (BS); and
align timings of the distributed antennas based on the second signal, and
wherein the second signal comprises time gap information for timing alignment between the plurality of distributed antennas.

12. The UE of claim 11, wherein the time gap information comprises a time gap between a reception timing of the first signal for each of the plurality of distributed antennas and a timing of a time resource allocated to the first signal.

13. (canceled)

14. A chipset configured to transmit and receive signals on a plurality of distributed antennas in a wireless communication system supporting sidelink, the chipset comprising:
at least one processor; and
at least one memory operably connected to the at least one processor and configured to, when executed, cause the at least one processor to perform operations comprising:
controlling a plurality of distributed antennas to transmit a first signal;
receiving a second signal from a base station (BS); and
aligning timings of the distributed antennas based on the second signal,
wherein the second signal comprises time gap information for timing alignment between the plurality of distributed antennas.

15. (canceled)
